(19) United States
(12) Patent Application Publication
(10) Pub. No.: US 2024/0293803 A1
(43) Pub. Date: Sep. 5, 2024

(54) Perovskite Material For Methane To Ethylene Conversion

(71) Applicant: UNM Rainforest Innovations, Albuquerque, NM (US)

(72) Inventors: Kannan Ramaiyan, Albuquerque, NM (US); Angelica Benavidez, Albuquerque, NM (US); Fernando Garzon, Albuquerque, NM (US); Luke Denoyer, Albuquerque, NM (US)

(73) Assignee: UNM Rainforest Innovations, Albuquerque, NM (US)

(21) Appl. No.: 18/663,018

(22) Filed: May 13, 2024

Related U.S. Application Data
(63) Continuation-in-part of application No. 18/320,931, filed on May 19, 2023, now Pat. No. 12,036,535.
(60) Provisional application No. 63/343,887, filed on May 19, 2022.

(51) Int. Cl. B01J 23/847; B01J 35/70

(52) U.S. Cl. CPC B01J 23/8474; B01J 35/733; B01J 2235/15; B01J 2235/30

(57) ABSTRACT

A catalyst comprising a barium niobate-based perovskite structure where, Mg and Ca has been used to dope the niobium sites along with one or more of Fe, Ni, Co, Y, Yb, W, Ta, and Pr.

### RELATED APPLICATIONS

This application is a Continuation-In-Part of U.S. Ser. No. 18/320,931 filed on May 19, 2023, which claims priority to U.S. Provisional Application No. 63/343,887, filed on May 19, 2022, both of which are incorporated herein in their entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Methane is the major component of many gas sources such as natural gas and shale gas hence it is cheap and unfortunately wasted in flaring that has resulted in more than 500 million tons of CO2 in 2022. Oxidative and non-oxidative coupling of methane (OCM and NOCM) have been actively researched to produce ethylene and higher olefins from methane to reduce flaring for a few decades although catalysts with commercially viable conversion rates have not yet been developed. Electrochemical OCM (E-OCM) is gaining attention due to its ability to regulate the oxide ion flux that will help reduce the over-oxidation of methane while also helping to activate methane. Fe-based catalysts have been shown to activate methane in both OCM, E-OCM and NOCM although suffering from coking-related durability challenges.

Methane conversion into value-added products such as olefins and aromatics is gaining increased attention in the wake of new natural gas reserve discoveries. E-OCM provides better product selectivity as the product distribution can be controlled by applied potential as well as the oxide ion flux.

Efficient on-site conversion of methane to value-added chemicals such as ethylene and higher hydrocarbons is also an active area of research as many recent discoveries of natural gas reserves made methane a cheap source of energy with an estimated reserve volume of 215 trillion cubic meters (TCM) worldwide. Due to these new discoveries, methane prices have dropped from $7-9 USD per million BTU in 2008 to roughly $2 USD per million BTU in 2020. Readily available amounts of natural gas have risen over 30% in the past 20 years although transporting it to retail locations remains challenging.^{[4]} Difficulties in transportation of natural gas has resulted in onsite venting and flaring of methane, which results in the release of greenhouse gases CH₄ and CO₂ to the environment apart from methane being wasted. Hence, direct conversion of methane to ethylene is highly desired due to ethylene's use as a building block for valuable commodity chemicals, in a wide variety of chemical industries.

Current technology for producing ethylene primarily centers around naphtha steam-cracking, employing high temperature steam-cracking process as a primary method (>750° C.), which incurs large energy losses and produces significant amounts of CO₂. Direct catalytic conversion of methane to ethylene allows for skipping of multiple steps that must be completed during steam cracking. For example, direct non-oxidative coupling of methane (NOCM) features methane coupling without requiring an oxygen source into ethylene and aromatic compounds. However, NOCM requires high operating temperatures and suffers from ill-defined catalyst mechanisms and significant coke formation. Oxidative coupling of methane (OCM) considers methane coupling at temperatures (˜750° C.) in low O₂ (or other oxidizing agents) gas environments on a catalyst surface.

Under OCM conditions, methane coupling to a partial oxidation product such as ethylene is thermodynamically feasible, although further oxidation products like CO and CO₂ are even more favorable. In addition, reaction between the desired product, C₂H₄ and oxygen to produce CO₂ (−1294 kJ/mol at 800° C.) is far more energetically facile in comparison to methane oxidation to produce CO₂ (−800 kJ/mol at 800° C.) predicted from HSC calculations (Collected using HSC Chemistry version 10.0.5.16 software from Outotec®). Hence difficulty in achieving ethylene selectivity has remained an issue for OCM.

A novel method attempting to circumvent the over-oxidation of methane to CO₂ is the electrochemical oxidative coupling of methane (E-OCM). The fine-tuning of potential within an electrochemical cell allows for the regulation of oxide ion flux from cathode to anode across the electrolyte material. Further, the extent of oxidation can also be manipulated by the applied bias. Thus E-OCM can theoretically help achieve the partial oxidation of methane to ethylene using oxide-ion conducting electrolytes while restricting the over-oxidation to undesirable products like CO and CO₂. Another recent consideration is using an Fe doped strontium molybdate (SFMO) perovskite catalyst that selective partial oxidation to ethylene is preferred at a specific electrochemical window during E-OCM.

Nevertheless, SFMO materials suffered from poor chemical stability under the operating conditions of E-OCM as strontium formed strontium carbonate upon exposure to methane along with significant coke formation. This is a major challenge for many newly developed electrolyte and electrocatalyst systems under high temperature operations and redox stability is essential for durable operation of these devices.

### BRIEF SUMMARY OF THE INVENTION

In one embodiment, the present invention provides a catalyst, device, system and method concerning a barium niobate-based perovskite system for effective OCM and E-OCM, where, Mg or Ca has been used to dope the niobium sites along with one or combinations of Fe, Ni, Co, Y, and Pr.

In another embodiment, the present invention provides a catalyst, device, system and method concerning a barium niobate-based perovskite system wherein the perovskite is Fe and Mg co-doped BaM_{0.33}Nb_{0.67-x}FeₓO_{3-δ} (BMNF) perovskite for effective OCM and E-OCM, where, M is one or both of Mg and Ca and is used to dope the niobium sites along with Fe.

In another embodiment, the present invention provides a catalyst, device, system and method wherein the chemical formula of these compounds is BaCa_{0.33}Nb_{0.67-x}MₓO_{3-δ} and BaMg_{0.33}Nb_{0.67-x}MₓO_{3-δ} where M is one or more of Fe, Co, Ni, Y, Yb, or Pr and the M content is varied from x=0.0 to x=0.33 and Ca and Mg is varied between 0.0 to 0.50.

In another embodiment, the present invention provides a catalyst, device, system and method wherein the chemical formula of these compounds is BaCa_{0.33}Nb_{0.67-x}MₓO_{3-δ} and BaMg_{0.33}Nb_{0.67-x}MₓO_{3-δ} where M is one or more of Fe, Co, Ni, Y, Yb, or Pr and the M content is varied from x=0 to x=0.60 and Ca and Mg are varied between 0.20 to 0.40.

In another embodiment, the present invention provides a catalyst, device, system and method of claim 1 wherein the incorporation of Fe or other transition metal ions in the crystal lattice results in mixed ionic electronic conductivity enabling electron and ionic transport to achieve effective OCM and E-OCM activity.

In another embodiment, the present invention provides a new catalyst based on Mg and Fe co-doped barium niobate perovskites. The perovskites of the present invention show excellent chemical stability in CH₄-rich environments up to 925° C. while showing methane activation properties from 600° C. E-OCM measurements indicated an ethylene production rate of 277 μmol cm⁻² h⁻¹ with a faradaic efficiency of 20% at 1 V and durable operation for six continuous days. XPS measurements indicate significant Nb valency reorganization providing chemical stability. The exceptional chemical stability of this perovskite material under methane exposure at high temperatures has significant importance as this material could be used as a catalyst and/or support in a wide variety of applications relevant for efficient energy conversion and storage.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1A shows PXRD patterns obtained for the as-prepared BMNF materials with various Fe doping.

FIG. 1B shows PXRD patterns of BMNF materials after exposure to pure methane at 900° C.

FIG. 1C shows TGA plots obtained for the as prepared BMNF powders in an air atmosphere

FIG. 1D shows TGA plots obtained for BMNF powders in pure methane atmosphere. The TGA curves in solid indicate the heating direction and curves in dots indicate the cooling response.

FIG. 2 shows mass spectroscopic plots obtained for the outlet stream during TPR measurements for the BMNF33 sample in the temperature range of 25-925° C. under 95% CH₄ and 5% O₂.

FIG. 3A shows conductivity data obtained for the three BMNF pellets in the temperature range of 600 to 900° C.

FIG. 3B shows cyclic voltammetry curves obtained for BMNF25 under CH₄ cathode environment.

FIG. 3C shows current and potential curves along with observed product stream as a function of time for the CV curve.

FIG. 4 is a cyclic voltammetry plot obtained for BMNF25 at 925° C. in a wide potential window of −1.5V to 1.0V at a scan rate of 1 mV/s in anode CH₄ environment. The air electrode was utilized as the reference electrode.

FIG. 5 shows CV curves obtained for BMNF25 at 925° C. in a wide potential window of −1.5V to 1.0V at a scan rate of 1 mV/s in anode CH₄ environment under continuous operation for three days.

FIG. 6 shows CV curves obtained for BMNF25 at 925° C. in a wide potential window of −1.5V to 1.0V at a scan rate of 1 mV/s in anode 4% H₂ environment.

FIG. 7 shows current and potential curves along with observed product stream as a function of time for the CV curve presented in FIG. 6.

FIGS. 8A, 8B, 8C, 8D, and 8E provide chronoamperometric data obtained for BMNF25 cell, (a) I-V plots obtained via the CA measurements, mass spec data obtained for the outlet stream during CA measurement for (b) H₂, (c) C₂H₄, (d) H₂O, and (e) CO₂.

FIGS. 9A and 9B show CV curves obtained for BMNF33 electrode at 900° C. in a wide potential window of −1.5V to 1.0V at a scan rate of 1 mV/s under 100 SCCM of (a) UHP CH₄ feed, and (b) 4% H₂ balanced in N₂ to the anode. The cathode was maintained with 100 SCCM O₂ supply.

FIGS. 10A and 10B show CV curves obtained for commercial LSM electrode at 850° C. in a wide potential window of −1.5V to 1.0V at a scan rate of 1 mV/s under 100 SCCM of (a) UHP CH4 feed, and (b) 4% H₂ balanced in N₂ to the anode. The cathode was maintained with 100 SCCM O₂ supply.

FIGS. 11A and 11B are SEM images obtained for (a) as-prepared BMNF33 and (b) after exposure to pure CH4 at 900° C. for one hour.

FIG. 12A is a crystal Maker view of the BMNF perovskite.

FIG. 12B is a schematic representation of methane adsorption on the Ba site in BMNF and water removal using adjacent O atom.

FIG. 12C is XPS data collected for O 1s for the BMN perovskite.

FIG. 12D is XPS data collected for Nb 3d for the BMN perovskite.

FIG. 12E is XPS data for O1s for BMNF33 perovskite.

FIG. 12F is XPS Nb 3d data collected for BMNF33 perovskite.

FIG. 13A shows PXRD patterns obtained for the Fe and Y doped BCN perovskite powders as prepared powders.

FIG. 13B shows PXRD patterns obtained for the Fe and Y doped BCN perovskite powders) after exposure to 4% H2 at 900° C. for an hour.

FIG. 13C shows PXRD patterns obtained for the Fe and Y doped BCN perovskite powders after exposure to pure CH4 at 900° C. for an hour.

FIG. 14 shows PXRD patterns obtained for the undoped barium niobate. PXRD pattern of Ca doped barium niobate is given for comparison.

FIG. 15A provides TGA plots obtained for BCNF17 in environments such as air, N2, and 4% H2/N2 with heating curves given as solid lines and cooling curves given as dots.

FIG. 15B provides TGA plots obtained for BCNF25 in environments such as air, N2, and 4% H2/N2 with heating curves given as solid lines and cooling curves given as dots

FIG. 15C provides TGA plots obtained for BCNF33 in environments such as air, N2, and 4% H2/N2 with heating curves given as solid lines and cooling curves given as dots

FIG. 15D provides TGA plots obtained for BCNY in environments such as air, N2, and 4% H2/N2 with heating curves given as solid lines and cooling curves given as dots

FIG. 15E provides TGA plots obtained for BCNFY in environments such as air, N2, and 4% H2/N2 with heating curves given as solid lines and cooling curves given as dots

FIG. 15F provides TGA plots obtained for BCN in environments such as air, N2, and 4% H2/N2 with heating curves given as solid lines and cooling curves given as dots

FIG. 16 provides TGA plots obtained under pure methane conditions for the prepared perovskite powders.

FIG. 17A is XPS Nb 3d data collected for all six compositions of perovskite powders as prepared.

FIG. 17B is XPS Nb 3d data collected for all six compositions of perovskite powders after exposure to 4% H2/N2 at 900° C.

FIG. 18 is an XPS Fe 2p plot obtained for as prepared and 4% H2 treated perovskite samples.

FIG. 19A is XPS O 1s spectra obtained for the perovskite powders before exposure to 4% H2/N2.

FIG. 19B is XPS O 1s spectra obtained for the perovskite powders after exposure to 4% H2/N2.

FIG. 20A provides SEM micrographs obtained for pellets of BCN.

FIG. 20B provides SEM micrographs obtained for pellets of BCNY.

FIG. 20C provides SEM micrographs obtained for pellets of BCNFY.

FIG. 20D provides SEM micrographs obtained for pellets of BCNF17.

FIG. 20E provides SEM micrographs obtained for pellets BCNF25.

FIG. 20F provides SEM micrographs obtained for pellets of BCNF33.

FIG. 21 is a SEM micrograph obtained for the undoped barium niobate pellet after sintering at 1400° C.

FIG. 22A provides electrical conductivity values obtained for the Y and Fe doped BCN pellets in the temperature range of 300° C. to 900° C.

FIG. 22B shows cyclic voltammetry curves obtained for BCNF25 under CH4 anode environment at 850° C.

FIG. 22C shows product distribution plots in parallel to applied potential and current as a function of time.

FIG. 23 shows mass spectroscopic plots obtained on the outlet stream during the E-OCM measurements with BCNF33 as the anode.

FIG. 24A shows mass spectroscopic plots obtained on the outlet stream during TPR measurements for the BCNFY sample in the temperature range of 25-800° C. under 95% CH4 and 5% O₂.

FIG. 24B shows ethylene yields obtained for various catalysts during the TPR measurements.

FIG. 24C shows yield and conversion obtained for all the catalysts during TPR measurements.

FIG. 25A is a mass spectroscopic analysis of the outlet stream during the TPR measurements under 95% CH4:5% O2 obtained for BCN.

FIG. 25B is a mass spectroscopic analysis of the outlet stream during the TPR measurements under 95% CH4:5% O2 obtained for BCNF17.

FIG. 25C is a mass spectroscopic analysis of the outlet stream during the TPR measurements under 95% CH4:5% O2 obtained for BCNF25.

FIG. 25D is a mass spectroscopic analysis of the outlet stream during the TPR measurements under 95% CH4:5% O2 obtained for BCNF33.

FIG. 26 shows a mass spectroscopic analysis of the outlet stream during the TPR measurements under 95% CH4:5% O2 obtained for the layered perovskite K2La2Ti3O10.

FIG. 27 shows TPR results obtained for 1% Pt-Al2O3 catalyst in 95% CH4-5% O2 flow.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting but rather to provide an understandable description of the invention.

In a preferred embodiment, the present invention concerns a barium niobate based perovskite system for effective OCM and E-OCM application, where, Mg or Ca has been used to dope the niobium sites along with Fe. The chemical formula of these compounds is BaCa_{0.33}Nb_{0.67-x}FeₓO_{3-δ} and BaMg_{0.33}Nb_{0.67-x}FeₓO_{3-δ} where the Fe content is varied from x=0 to x=0.33. In another embodiment, the chemical formula of these compounds is BaCa_{0.33}Nb_{0.67-x}FeₓO_{3-δ} and BaMg_{0.33}Nb_{0.67-x}FeₓO_{3-δ} where the Fe content is varied from x=0 to x=0.60 and where Ca and Mg is varied between 0 and 0.40.

This class of materials due to the incorporation of Fe in the crystal lattice show mixed ionic electronic conductivity that is essential for electron and ionic transport to achieve effective OCM and E-OCM activity. Their physical and chemical properties evaluated using TGA, XRD, XPS and FT-IR measurements demonstrate very good chemical stability under OCM conditions. TGA under methane environment further reveal adsorption and activation of methane in a perovskite material at about 600° C.

The catalysts were further examined for OCM along with structural and chemical stability characterizations. Ethylene production was observed to increase with increasing Fe content in the perovskite structure.

Fe and Mg co-doped BaMg_{0.33}Nb_{0.67-x}FeₓO_{3-δ} (BMNF) perovskite material has been demonstrated to resist the carbonate formation under CO₂ environments at elevated temperatures. Further, Fe is incorporated in the crystal lattice and hence should resist coke formation unlike Fe—O based catalyst systems that form carbide and coke in carburizing environments.^{[29]} This is highly relevant for OCM which involves exposure to CH₄, and CO₂ at elevated temperatures, Thus, this material was tested for chemical stability and OCM conversion with three different iron doping levels (x=0.33, 0.25, and 0.17 (BMNF33, BMNF25, and BMNF17 respectively)).

Specifically, these powders were exposed to pure methane at temperatures up to 925° C. and studied their PXRD patterns before and after exposure. Electrochemical measurements were carried out in a home-made button cell set up. For electrochemical measurements, BMNF with varying Fe content in combination with Gd doped Ceria (GDC) in a 65:35 ratio was used as the anode while Sr₂Fe_{1.5}Mo_{0.5}O_{6-δ} (SFMO) mixed with GDC in 65:35 ratio was used as the cathode. LSGM pellets with a 0.9 mm thickness and 20 mm diameter were utilized as the electrolyte. E-OCM measurements were carried out at 850° C. and 925° C. at methane flow rates of 100 SCCM to the anode and O₂ flow rates of 100 SCCM to the cathode. Silver mesh and gold wires were used as current collectors. Electrochemical measurements were also carried out in 4% H₂ balanced in N2 for comparison purposes.

One of the major challenges for many metal oxide electrodes studied for E-OCM is their chemical stability in carbon-rich environments under high operating temperatures relevant for E-OCM. Hence, investigating the crystallinity of the prepared BMNF materials before and after exposure to methane at elevated temperatures is key in assessing the likelihood of the perovskite maintaining its structure in highly reducing methane environments. The current operating temperatures for the electrochemical oxidative coupling cells may reach as high as 925° C. for testing purposes, with durability tests being done at a maximum of 925° C. for multiple days. However, reducing the operating temperature to as low as 600° C. is increasingly sought after in recent times.

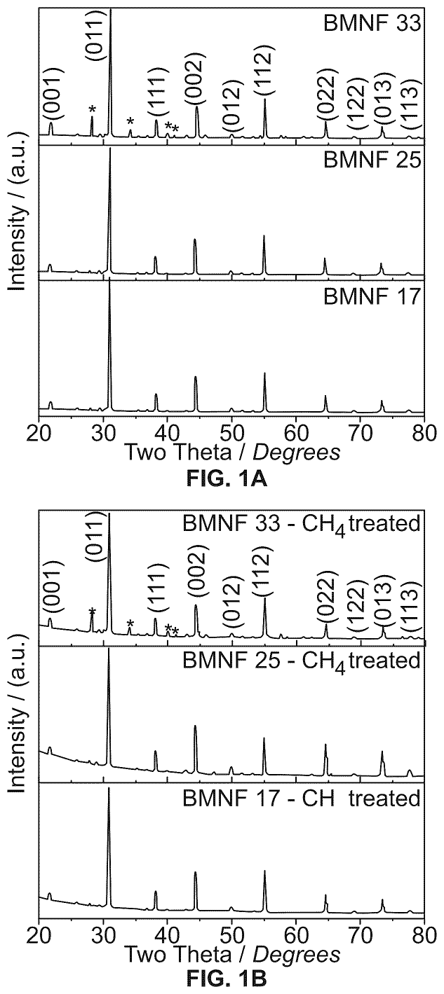

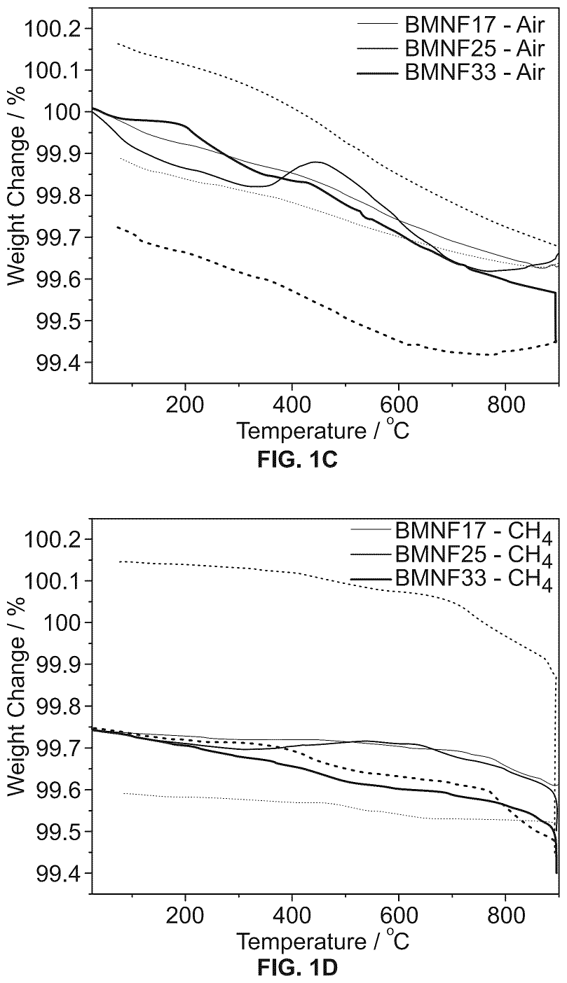

All three prepared BMNF compositions (x=0.17, 0.25, and 0.33) were exposed to methane in a TGA set up and analyzed them through PXRD before and after exposure to CH₄. TGA in air environment is also recorded for comparison purposes. PXRD patterns obtained for as-prepared BMNF powders are shown in FIG. 1a, which displays the formation of cubic perovskite structure with a space group=Pm-3m (No. 221).

With the incorporation of smaller Fe³⁺ ions over Nb⁵⁺, the peak positions shifted towards higher two theta values as expected from their Shannon ionic radii. TGA measurements carried out in air in the temperature range of 25° C. to 900° C. did not show any significant weight change with a maximum weight loss of 0.4% observed for BMNF33 after holding at 900° C. for one hour (FIG. 1c). This could be due to some lattice oxygen lost in equilibrating with its environment. TGA measurements under similar heating conditions in pure CH₄ environment showed similar weight changes with a maximum weight gain of 1.75% observed for BMNF25 while BMNF33 showed a maximum weight loss of 1% at 900° C. (FIG. 1d). The marginally higher weight loss under CH₄ environment (1% in CH₄ vs 0.4% in air) could be due to the lattice oxygen on the exposed surface reacting with methane and as a result leaving the crystal structure. The lack of weight gain indicates the possible lack of coke formation during the TGA measurements.

SFMO powders under similar operating conditions showed a weight gain of about 40 to 60% that was associated with significant coke formation and crystal structure collapse. To investigate any possible change to crystal structure, the CH₄ exposed powders in PXRD were analyzed. As shown in FIG. 1b, the cubic perovskite structure is retained in all three samples and do not show any new peak formation or change in the peak positions associated with the cubic perovskite structure. Interestingly, the impurity peaks observed in the as-prepared BMNF33 also retained their position and relative intensity after exposure to methane in the TGA set up. The ratio between peaks in both as-prepared powders and CH₄ exposed samples remained the same indicating the complete crystallinity retention. Thus, PXRD measurements in combination with TGA provide the first evidence of significant chemical stability for the BMNF material in E-OCM operating conditions. This is in complete contrast to the SFMO powders that formed SrCO₃, SrMOₓ, and MoOₓC_{y} upon exposure to methane under similar operating conditions.

Similar to SFMO, the expected reactions for the constituents of BMNF perovskites such as Ba and Mg upon exposure to methane was the formation of carbonates such as BaCO₃, and to some extent MgCO₃ along with agglomeration of carbon (coking) on the surface that would result in significant weight gain. However, the cubic BMNF perovskite material showed no significant weight change along with complete retention of its crystal structure as observed from FIG. 1a to 1d.

The stability of the BMNF structure in methane environment is important due to the constant methane supply to the electrode, and evolution of carbon products such as C₂H₄, CO, and CO₂ during OCM and E-OCM processes. High temperature operations render carbonate formations on Mg oxide surface as unfavorable. The Gibbs free energy of reaction for CO₂ is ΔG_{R}≈−800 kJ mol⁻¹ throughout the temperature range being tested (800-900° C.) and would be the dominant product if the reaction is not controlled specifically to produce partial oxidation product such as ethylene by oxide ion flux and applied potentials. To understand this, temperature programmed reaction measurements were carried out where first the BMNF25 powder was exposed to a gas mixture containing 95% CH₄ and 5% O₂. The exposed powder was analyzed for BaCO₃ and coke formation while the outlet stream was analyzed by mass spectroscopy.

Temperature programmed reaction of CH₄ and O₂ on BMNF

Temperature programmed reaction (TPR) measurements under gas mixtures of CH₄ and O₂ on a catalyst surface will help evaluate the onset temperature of catalytic activity of a new catalyst towards oxidative coupling of methane (OCM) and provide information about the product distribution. The TPR measurements were taken by passing a mixture of 95% CH₄:5% O₂ at a flow rate of 100 SCCM and a heating rate of 5° C./min to 925° C. followed by a hold at 925° C. for one hour.

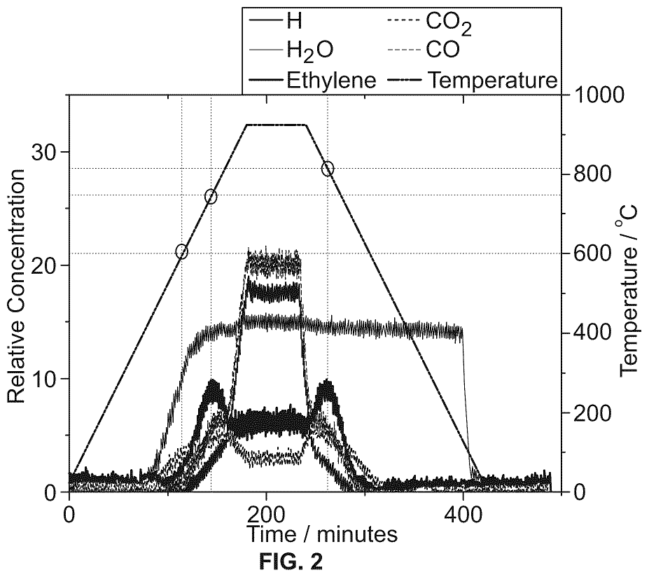

Reported TPR measurements on SFMO under three different CH₄ to O₂ ratios (100% CH₄, 95% CH₄:5% O₂, and 90% CH₄:10% O₂) revealed maximum coke formation (100% weight gain) under the 95% CH₄:5% O₂ mixture. SFMO perovskites showed coke formation to start at 800° C. along with other products such as CO, CO₂, H₂ and small quantities of ethylene. Mass spectra analysis on the outlet stream of TPR measurements obtained with BMNF33 is given in FIG. 2, where the onset of ethylene production starts at temperatures as low as 600° C. and reaches the maximum in the temperature range of 750-800° C. One of the most studied catalyst for OCM reaction, Mn—Na₂WO₄, is reported to show methane conversions at 800° C. at much higher CH₄ to O₂ ratio.^{m} Hence, a much lower onset temperature of 600° C. for BMNF33 indicates an ability for reducing the OCM operating temperatures. Interestingly, the contribution from CO and CO₂ is comparatively smaller than that of ethylene in this temperature range. However, further increase in temperature results in increased CO production. This could be due to a multitude of factors. For example, at about 900° C., the dry reformation of methane (CH₄+CO₂=2CO+H₂) becomes thermodynamically preferred reaction that could explain the rise in CO and H₂ concentration while that of ethylene and CO₂ decrease. Also, ethylene is more reactive than methane in general and the decline in ethylene concentration could also be due to possible reaction between produced ethylene and oxygen leading to increased CO production. For comparison, a bare tube measurement with no catalyst in the temperature range of 25-900° C. was run. No gas phase reactions take place till the temperature reached about 875° C. At 900° C. The product stream is dominated by H₂O, CO and H₂ with smaller contributions from ethylene and CO₂. HSC calculation involving 95% CH₄ and 5% O₂ in the investigated temperature range indicated the CO to be the major product at temperatures above 600° C. although this process could be kinetically limited. The above provided results indicate the catalytic activity of BMNF perovskites to activate methane towards ethylene production with higher selectivity in the temperature range of 600-800° C. The carbon atom balance during the TPR measurement is close to 100% reiterating the lack of coke formation with this catalyst. A maximum conversion of 12.5% and a selectivity of 50.3% was observed from BMNF33 catalyst at 800° C. The weight gain measurements carried out on the sample before and after TPR measurements did not reveal any weight gain further indicating the absence of coking.

### Electrochemical Properties of BMNF Materials

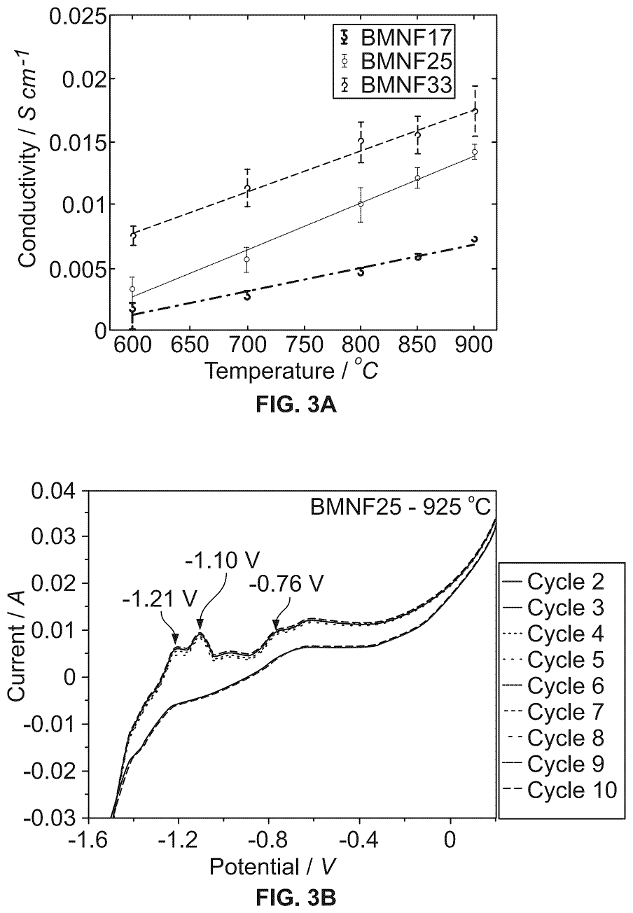

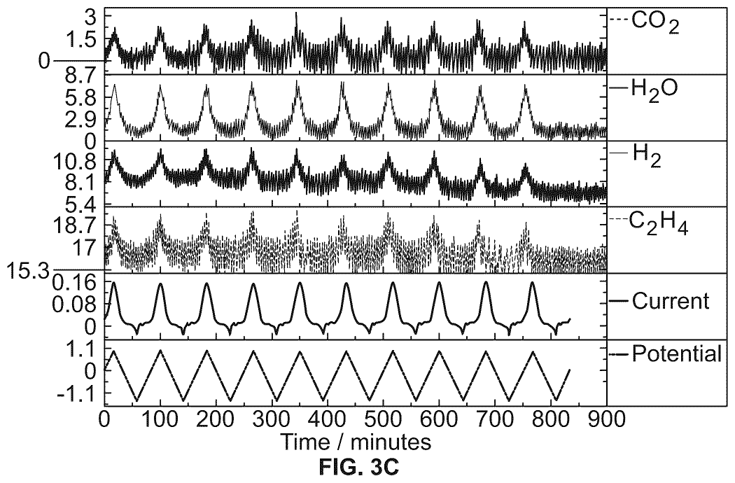

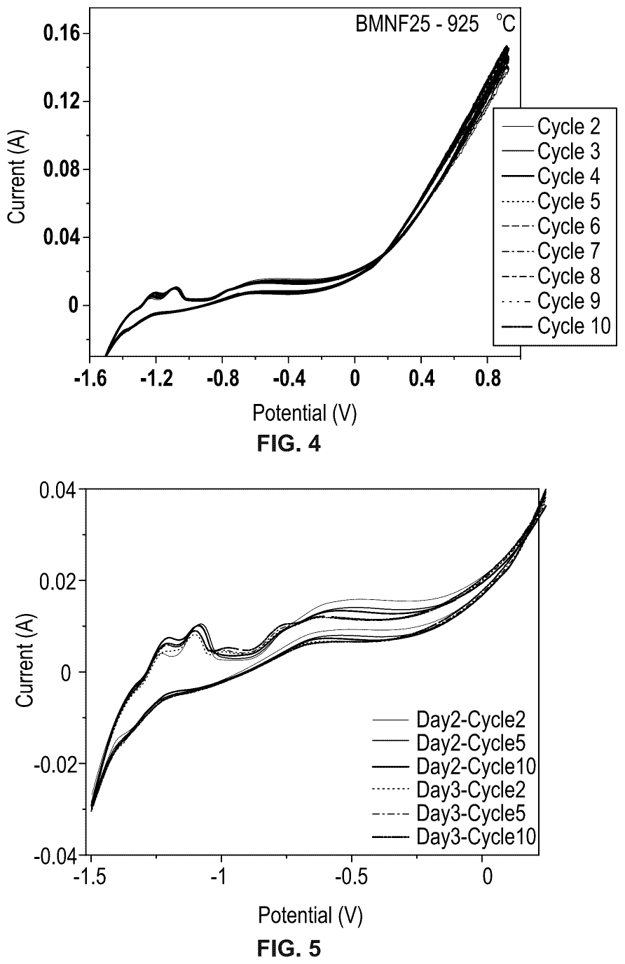

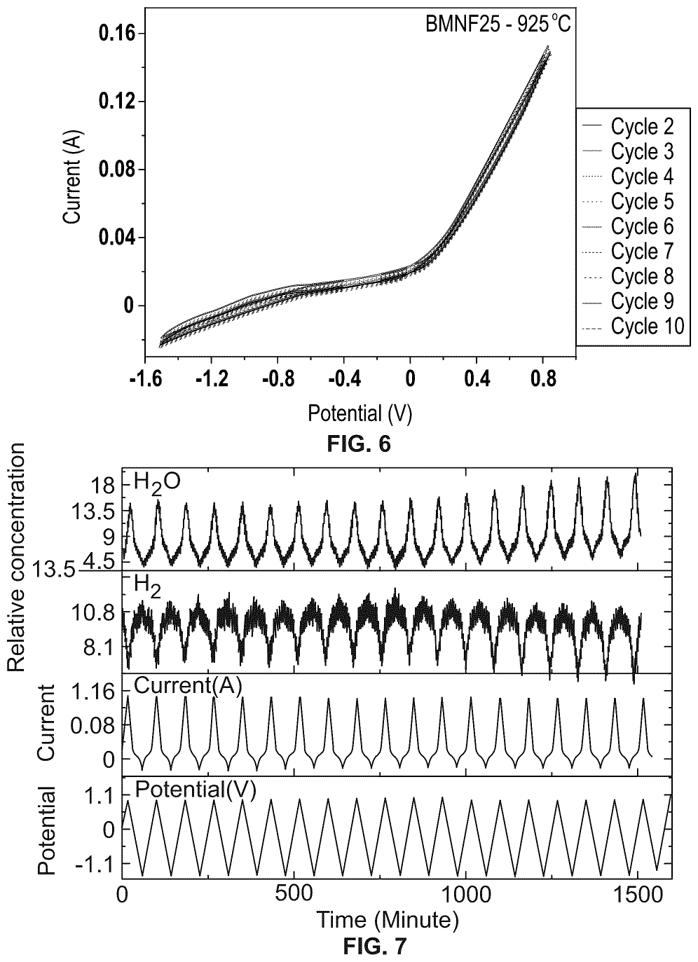

After establishing the chemical stability of BMNF perovskite and its catalytic activity towards methane activation for OCM application through TGA, PXRD, and TPR measurements, electrochemical characterization of the BMNF perovskites was carried out. The conductivity plots obtained for the three BMNF pellets via electrochemical impedance measurements are given in FIG. 3a where a maximum conductivity of 17 mS cm⁻ was obtained for BMNF33 while that observed for BMNF17 is only 7 mS cm⁻. The parent BaMg_{0.33}Nb_{0.67}O_{3-δ} showed a negligible conductivity in the entire investigated temperature range despite aliovalent Mg doping on Nb sites. E-OCM measurements were carried out in a setup with LSGM as electrolyte (0.9 mm thickness and 20 mm diameter), 65:35 mixture of SFMO/GDC as the cathode and a 65:35 mixture of BMNF/GDC as the anode. The electrodes were brush painted on the LSGM pellet, before being sintered at 1175° C. to remove any impurities. LSGM was chosen for electrolyte as the SFMO tend to react with YSZ electrolyte. Cyclic voltammetry (CV) measurements carried out on this cell using BMNF25 as the anode at a scan rate of 1 mV/s in a wide potential window (−1.5V to 0.9V against the air reference electrode) is shown in FIG. 4 while the magnified plot between −1.5 V to 0.1 V is given in FIG. 3b. The CV plots indicate clear catalytic activity towards methane activation at very low overpotentials near −0.75 V. The full window scan measured between −1.5V and 1.0V shown in FIG. 4 indicate a linear rise in current from 0.0V to 1.0V that suggests a constant surge of oxide ions across the electrolyte that should aid the E-OCM process. The CVs further indicate the durability of BMNF25 under these harsh E-OCM conditions as no significant change in peak intensity or shape is observed over 10 hours of electrochemical cycling between −1.5 V to 1.0 V. The CV measurements taken after two days of continuous operation remained nearly identical (FIG. 5) further emphasizing the durability of BMNF25. For comparison, SFMO based electrodes lost all characteristic peaks within a few CV cycles. CVs measured in 4% H₂ are given in FIG. 6 which indicate none of the characteristic peaks in the −1.3 to −0.5 V region obtained in methane environment. This further demonstrates the role of BMNF25 material in specifically activating methane in a well-defined electrochemical window. These peak positions are similar to SFMO based electrodes which showed methane activation in the potential range of −0.75 V to −0.5 V. The outlet stream of the anode is analyzed continuously by mass spectroscopic measurements to understand the product distribution along with the role of applied bias on E-OCM. The CV results obtained for BMNF25 as a function of time along with the mass spectroscopy results are presented in FIG. 3c while that obtained for BMNF25 under 4% H₂ flow is presented in FIG. 7. The results clearly indicate the methane activation property of BMNF25 as ethylene and hydrogen is produced under pure CH₄. Interestingly, the methane activation products such as ethylene, CO₂, H₂O and H₂ all reached their peak value at the maximum positive potential on the studied potential window i.e., 1.0 V. This is in contrast to previous results with SFMO-075Fe based electrodes where, ethylene production was peaked at −0.75 V in accordance with the methane activation peak in CV. This could possibly be due to the low conductivity of BMNF materials that has resulted in very low current densities at −0.75 V (>10 mA cm⁻²) in comparison to currents at 1.0 V (˜160 mA cm⁻²).

The low currents could be due to a lower electronic conductivity of BMNF perovskites coupled with low surface area that is normally associated with high-temperature solid state synthesis. For example, the maximum conductivity obtained for BMNF25 through electrochemical impedance measurements is 13 mScm⁻ at 900° C. which is significantly lower than the conductivity of typical solid oxide electrode materials such as LSM which is about 5.5×10³ S m⁻¹ at 800° C.

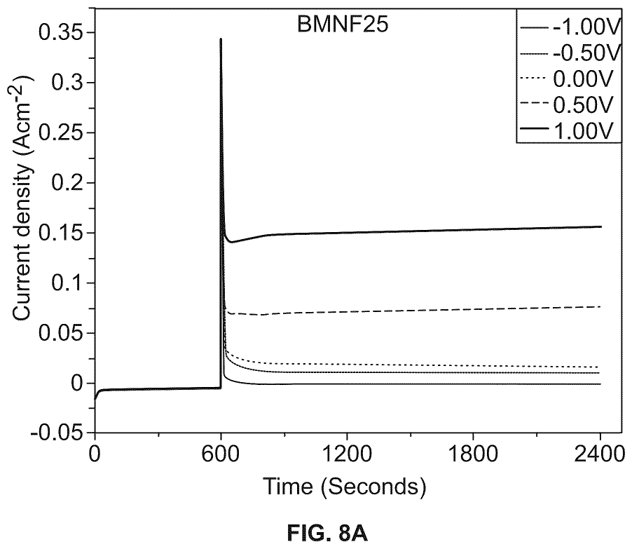

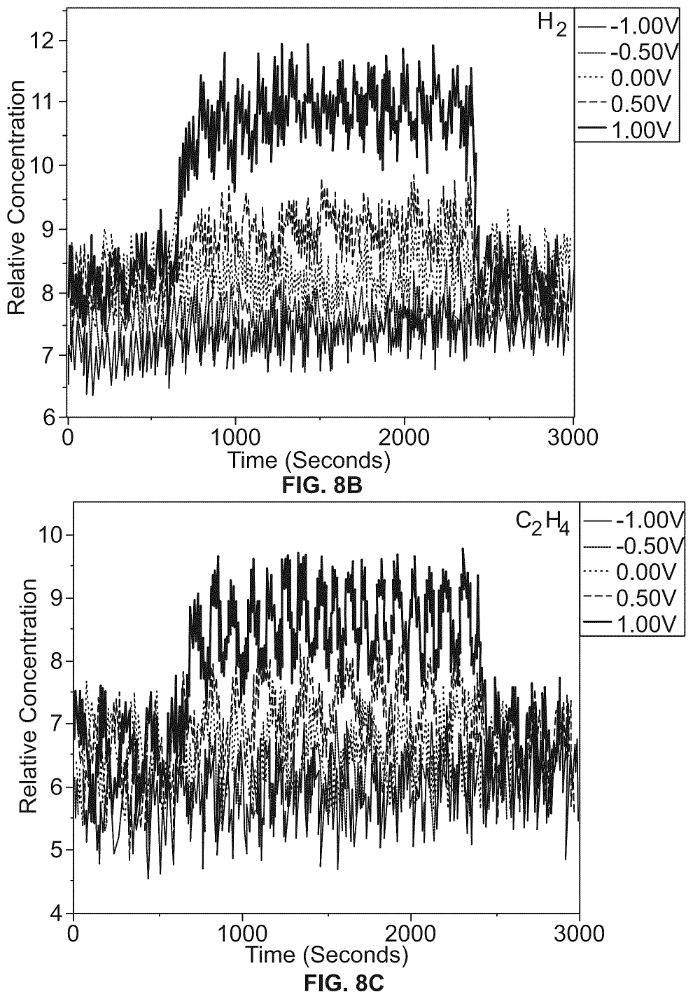

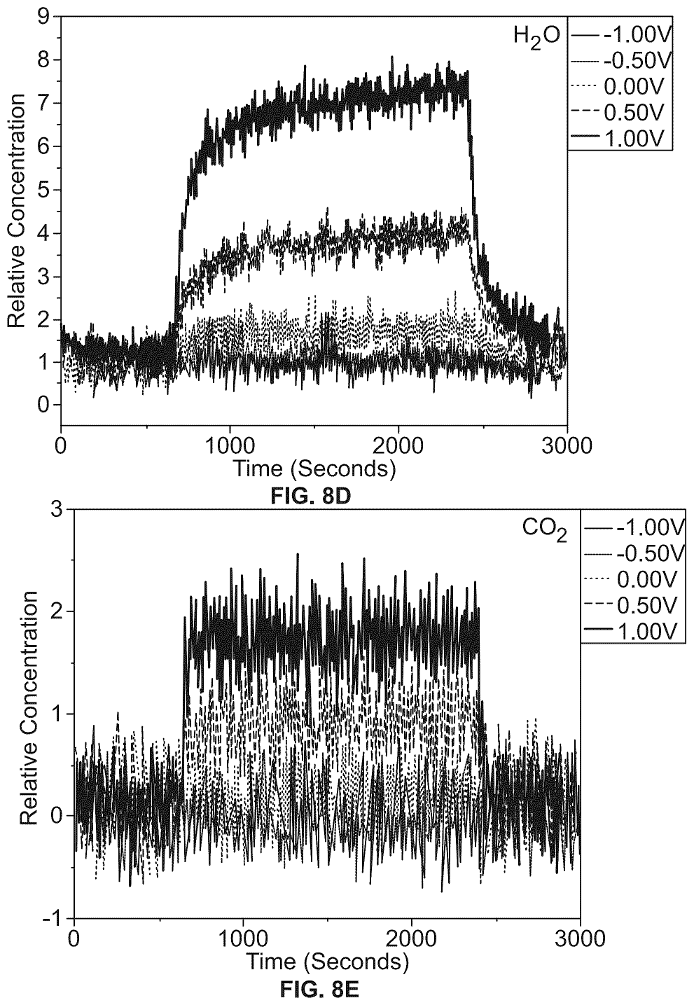

Chronoamperometric measurements on this cell once again showed quantifiable ethylene and hydrogen production only at high positive applied potentials (FIG. 8). A maximum ethylene production rate of 277.2 μmol cm⁻² h⁻¹ at a faradaic efficiency (FE) of 20% was observed at 1.0 V for this BMNF25 based cell while the FE for producing CO₂ was 39%. This is about four times higher than the faradaic efficiency obtained with SFMO electrode which produced mostly complete oxidation products such as CO₂ and H₂O. This result clearly indicates the propensity of this material to produce ethylene even at high applied biases that tend to favor CO₂ production. The FE towards H₂O production could not be satisfactorily calculated due to water condensing in the lines and it's deteriorating effect on the mass spec instrument. While thermocatalytic activity inferred from TPR measurements indicated a methane activation temperature of about 600° C., E-OCM results are obtained at 925° C. due to the low electrical conductivity of BMNF. Nevertheless, both measurements indicated a better selectivity towards ethylene despite different operating temperatures.

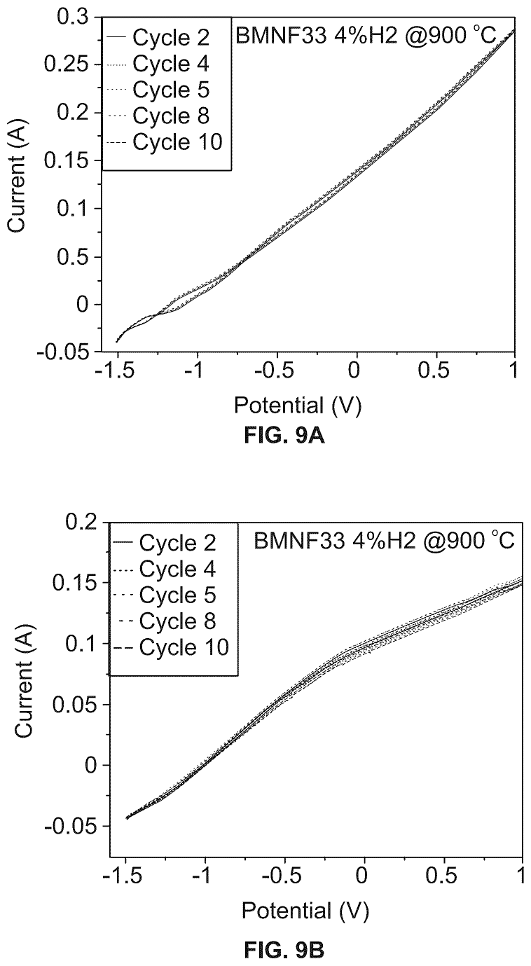

Interestingly, E-OCM measurements with the higher Fe doped perovskite BMNF33 as the electrode resulted in complete oxidation of methane and the product stream is dominated with CO₂ and H₂O with significantly lower production of ethylene in comparison to both BMNF17 and BMNF25 based electrodes. The higher Fe doping in the BMNF33 could be a reason for this overoxidation of methane towards CO₂. However, the impurities Mg₂Fe₂O₅ observed in PXRD with BMNF33 could also have played a role in the overoxidation although it is not clear at this point. CV measurements with BMNF33 in CH₄ indicate less defined peaks while in 4% H₂ show no identifiable peaks (FIG. 9a and FIG. 9b) and mass spectra analysis of the outlet for BMNF33 electrode indicate complete oxidation products such as CO₂ in comparison to BMNF25. Chronoamperometric measurements for BMNF33 once again indicated the complete oxidation products such as CO₂ all indicating the adverse impact of higher Fe doping.

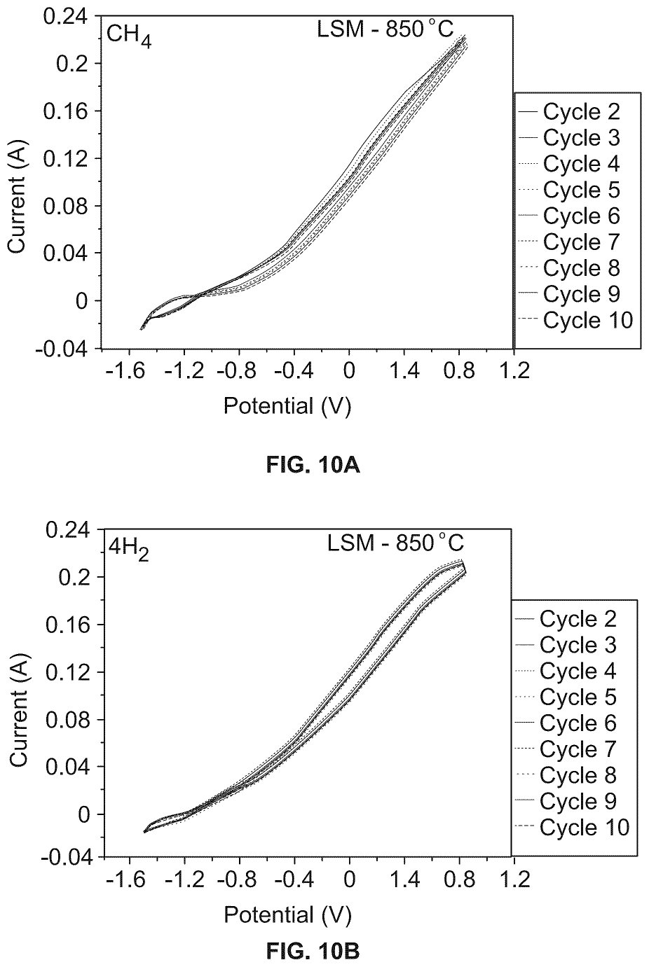

Nevertheless, BMNF perovskites showed remarkable chemical stability and maximum E-OCM activity was obtained with BMNF25. Further improvements in electrical conductivity as well as surface area are required for BMNF materials to fully utilize their methane activation properties toward ethylene production. For comparison, E-OCM measurements were carried out with commercial LSM catalyst as anode and CVs obtained under CH₄ and 4% H₂ are given in FIG. 10a and FIG. 10b. Both CVs are featureless in comparison to BMNF25 electrode under both CH₄ and 4% H₂ environments once again reaffirming the role of BMNF25 in activating methane.

### Mechanistic Analysis

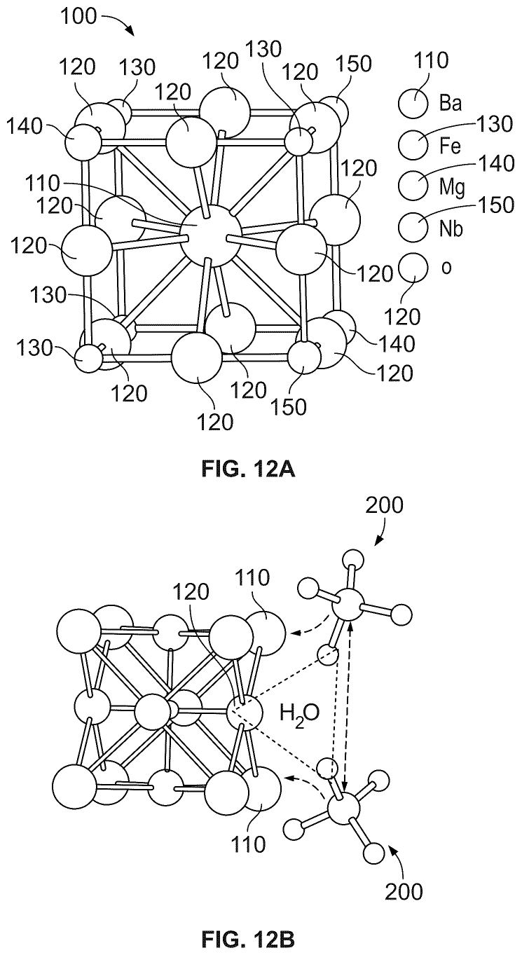

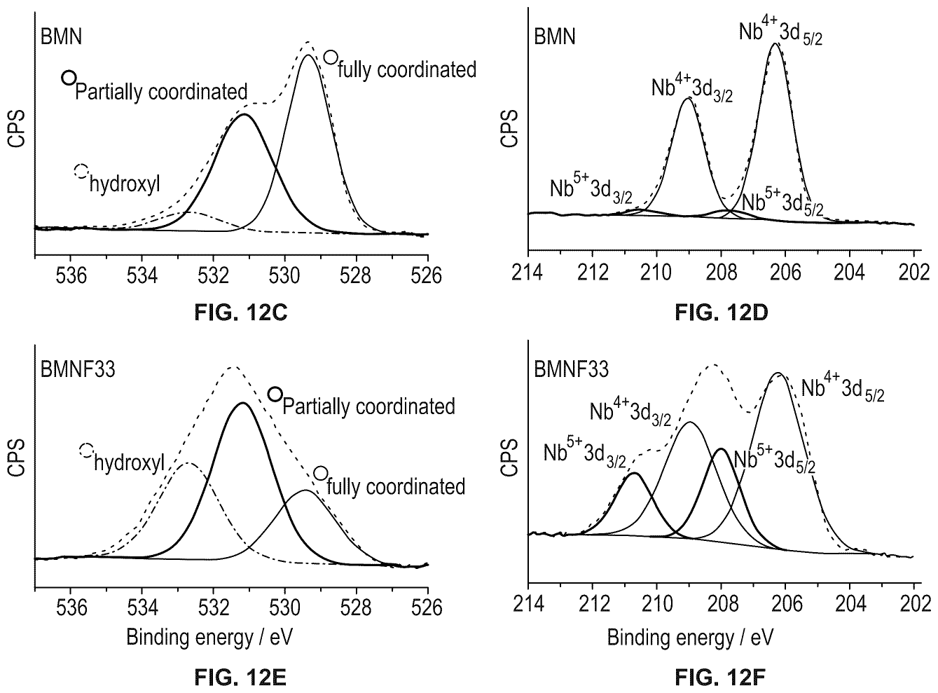

The cubic perovskite structure created in CrystalMaker® is given in FIG. 12a where both Mg and Fe are incorporated on the Nb site resulting in oxide ion vacancy creation. In a preferred embodiment as shown in FIG. 12a, a catalyst comprising a barium niobate-based cubic perovskite structure 100 where, Mg and Ca has been used to dope the niobium sites along with Fe. Cubic perovskite structure includes barium 110 at the center with oxygen 120 bonded thereto. Bonded to the oxygen 120 are Fe 130, Mg 140, and Nb 150.

The doping of Mg²⁺ and Fe³⁺ may occur at the Nb site as their Shannon ionic radii (0.72 Å and 0.645 Å respectively) matches better with Nb (Nb⁴⁺-0.68 Å, Nb⁵⁺-0.64 Å) than Ba²⁺ (1.35 Å) which also support oxygen vacancy creation. XPS results obtained for BMN and BMNF33 are shown in FIG. 12c-12f. The incorporation of Mg on Nb sites in BMN has resulted in oxygen vacancy creation as about 50% of the oxygen atoms are partially coordinated that is attributable to neighboring oxygen vacancy. This partially coordinated oxygen concentration increased to 74.9% in BMNF33 indicating a further rise in oxygen vacancy upon Fe doping (Table 1):

TABLE 1
XPS quantification of the peaks corresponding
to oxygen and Nb in the Mg only doped (BMN)
and Mg and Fe codoped (BMNF) barium niobates.

| | O1s fully | O1s Partially | | |
|---|---|---|---|---|
| Material | coordinated (%) | coordinated (%) | Nb⁴⁺ (%) | Nb⁵⁺ (%) |
| BMN | 49.7 | 50.3 | 94.8 | 5.2 |
| BMNF33 | 25.1 | 74.9 | 70.5 | 29.5 |

Interestingly, in BMN Nb is mainly in 4+ oxidation state with Nb in 5+ oxidation state contribution is only 5%. However, upon Fe doping Nb⁵⁺ contribution has increased six-fold to about 30%. Ceramic materials with high acidic character tend to be stable in carbonate forming environments. For example, the incorporation of acidic Ti⁴⁺ ions in SrCo_{0.8}Fe_{0.2}O_{3-δ} is reported to show decreased carbonate formation in pure CO₂ environments at temperatures up to 950° C. Thus, the highly acidic Nb⁴⁺ may be the reason for BMN's chemical stability.

Importantly, upon Fe^{2+/3+} incorporation, part of Nb⁴⁺ is converted to Nb⁺⁵ that could provide further stability enhancement in carbonate forming environments. On the other hand, among alkaline earth metals, Ba is reported to adsorb methane, CO, and CO₂ in a wide variety of temperatures. BMNF has previously been reported for CO₂ sensing application in the temperature range of 500 to 700° C. As shown in FIG. 12b, barium sites 110 in BMNF act as adsorption sites for methane 200 while adjacent lattice oxygen 120 help remove two hydrogen atoms as water as shown in the scheme. This type of surface oxide ions (O⁻) reacting with methane is well-known for metal oxide catalysts. However, a continuous removal of surface oxygen and hydrogen from methane will lead to crystal structure collapse, loss of activity, and coke formation. However, no change in BMNF crystal structure was observed and no coke formation was observed either ruling out the continuous removal of oxygen atom from the site. This could occur due to the higher Nb⁵⁺ concentration that would increase the attraction towards the negative oxide ions and resist their continuous removal.

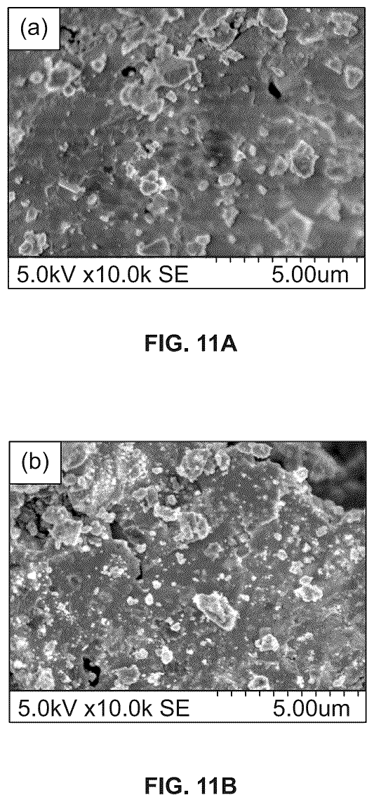

Similarly, Ba based metal oxides are known to form barium carbonate under carbon rich conditions due to the higher stability of BaCO₃ under these conditions. Nevertheless, the BMNF perovskite has remained stable under these carbon rich environments and no carbonate or coke formation was observed either. The oxygen mobility in this cubic perovskite is very limited which may have helped to preserve the crystal structure and the surface oxygen has to be replenished with incoming oxide ions (E-OCM) or oxygen molecule (OCM) for sustained catalytic activity. This is supported by the fact that despite significant oxygen vacancies as evidenced from XPS measurements, BMN show poor conductivity (>1 S/cm). The low oxide ion mobility and the higher acidity associated with Nb^{4+/5+} ions may have helped reduce both coke formation and carbonate formation. The presence of Nb tends to increase stability under SOFC operating conditions due to its redox stability. SEM images obtained for as-prepared and CH₄ exposed samples do not show any morphological change or carbon deposition in EDS measurements (FIG. 11). Another mode of methane activation utilizing oxide ion conducting membranes is the Non-Faradaic Electrochemical Modification of Catalytic Activity (NEMCA) which is normally associated with Faradaic efficiencies much higher than 100%. However about 20% Faradaic efficiency for ethylene production was observed indicating the absence of NEMCA mechanism in the E-OCM measurements.

The high chemical stability along with methane activation properties observed for BMNF perovskites open new opportunities for fine tuning its catalytic activity through various dopants and can also be used as a support for conventional methane activation catalysts where catalyst—support synergy could help achieve better conversion and selectivity towards desired products.

Mg and Fe co-doped barium niobates were synthesized for application in E-OCM. Chemical stability studies by TGA, PXRD, and TPR all revealed that all the three prepared compositions possess good chemical stability under conditions relevant for E-OCM. The chemical stability could be due to the increased acidity of Nb^{4+/5+} ions in the crystal lattice. TPR measurements further revealed that the onset of ethylene production at about 600° C. that is significantly lower than well-known OCM catalysts. E-OCM measurements were operated at much higher temperatures in order to get good oxide ion conductivity in BMNF revealed about four times higher faradaic efficiency towards ethylene production than SFMO electrodes at 1.0V indicating this material's unique ability to selectively produce ethylene even under extremely oxidizing conditions. XPS measurements indicate a possible valency reorganization for Nb in Fe doped BMNF compositions that improve the chemical stability. The results demonstrating the methane activation properties of BMNF along with its unique chemical stability under carburizing environments open up new avenues for finding a better catalyst for methane activation under different methodologies.

### Materials

BaMg_{0.33}Nb_{0.67-x}FeₓO_{3-δ} (BMNF) was formed from the following precursors: BaCO₃, C₄Mg₄O₁₂·H₂MgO₂·5H₂O (Magnesium carbonate hydroxide pentahydrate), Nb₂O₅, and Fe₂O₃. The electrolyte material La_{0.9}Sr_{0.1}Ga_{0.8}Mgo_{0.2}O_{3-δ} (LSGM), and Ce_{0.8}Gd_{0.2}O₂ (GDC) were purchased from Millipore Sigma®. Gold Wire used as the leads in the electrochemical cell was purchased from Rio Grande Jewelry Supply®. Silver mesh current collectors, high temperature sealing paste (CAP552), thinner for high temperature sealing paste (CAP-552-T), alumina slurry (ALSL), and alumina felt seals were purchased from Fuel Cell Materials®. Alumina tubes were purchased from AdValue Technology®.

Material synthesis: The perovskite anode material BaMg_{0.33}Nb_{0.67-x}FeₓO_{3-δ}, was produced using solid-state synthesis methods. Initially, the metal oxide and metal carbonate precursors were weighed in stoichiometric ratios to produce 7 grams of BaMg_{0.33}Nb_{0.6-x}FeₓO_{3-δ} with x values of 0.33, 0.25, 0.17, and 0.00 corresponding to BMNF33, BMNF25, BMNF17 and BMN respectively. The metal oxide precursors were added to a zirconia ball-milling jar and isopropyl alcohol (IPA) (30 mL) was added (as liquid for ball milling). Each jar contained 16 individual 10 mm diameter Zirconia milling balls and powder was milled for 6 hours. After milling, ball-milling jars were dried at 120° C. in an oven. The dried powders were calcined at 1000° C. using a 12 hour hold and 5° C. minute⁻¹ heating and cooling rate in a three-phase furnace. The calcined powders were further ball milled for 6 hours in IPA followed by drying at 120° C. Thus, obtained powders were pressed into 2 individual pellets using a 12 mm die. Both uniaxial pressing, followed by isostatic pressing were used. The initial uniaxial pressing is done at 1000 psi for 3 minutes followed by isostatic pressing done at 240 MPa for 3 minutes. Each pressed pellet weighed about 2.0 grams. The pellets were soaked in excess parent powder in an alumina crucible for calcining. The pellets are calcined at 1400° C. for 24 hours with a 5° C. minute⁻¹ heating and cooling rate in a Carbolite tube furnace. After this process, the pellets were used for further measurements. BMNF powder is typically black in color, with lighter shades corresponding to a lower iron concentration. The Fe free BMN was yellowish in color. The cathode Sr₂Fe_{1.5}Mo_{0.5}O_{6-δ} (SFMO) powders were prepared by a microwave assisted combustion methods. SFMO was chosen due to its very high electrical conductivity and compatibility with LSGM. The LSGM pellets for electrolyte application are prepared from commercially obtained LSGM powder. About 1.6 g of LSGM powder was pressed uniaxially using a 25 mm die. The pressed powder was then pressed in the isostatic press at 240 MPa for three minutes followed by sintering at 1175° C. for 12 hours using a 3° C. minute⁻¹ heating and cooling rate.

### Physical Characterization:

BMNF powders were characterized by powder X-ray diffraction (PXRD), thermogravimetric analysis (TGA), scanning electron microscopy (SEM), and X-ray photoelectron spectroscopic (XPS) measurements. TGA was carried out in air and pure methane environments. TGA measurements were carried out using TA Q600 SDT instrument in air and in pure methane environments with flow rate of 50 ml-pm in the temperature window of 25° C. to 900° C. at a heating and cooling rate of 5° C. minute⁻¹ and held at 900° C. for one hour. XPS measurements were performed on a Kratos Ultra DLD spectrometer using a monochromatic Al Kα source operating at 150 W (1486.6 eV). The operating pressure was 5×10⁻⁹ Torr. Survey spectra were acquired at a pass energy of 160 eV and high-resolution spectra were acquired at a pass energy of 20 eV. XPS data was processed using Casa XPS software. X-ray diffraction measurements were done in a PANalytical Xpert Pro instrument using Cu Kα radiation and operating at 40 kV and 40 mA on a zero-background holder. SEM-EDX measurements carried out on Hitachi S-5200 scanning electron microscope.

### Electrochemical Measurements:

BMNF (200 mg) is mixed with Ce_{0.8}Gd_{0.2}O₂ (GDC) (100 mg), terpineol (630 mg), and cellulose (70 mg) to produced 1 g of BMNF ink. This mixture is probe sonicated using a Tekmar probe sonicator for 6 minutes in 30 second intervals (on/off). The SFMO cathode was made using SFMO (200 mg) and GDC (100 mg) with terpineol (630 mg) as a dispersant and cellulose (70 mg) added for induced porosity. The resultant mixture is ultrasonically mixed before electrode painting. The BMNF anode is brush-coated onto the LSGM electrolyte in a 1×1 cm² electrode area. 3 layers of material are coated onto the electrolyte, with a heat gun used to dry each subsequent layer. The SFMO cathode is brush-coated with the same specifications. This cell is placed into a 3-phase furnace and heat-treated at 1175° C. for 12 hours in air at a 3° C. minute⁻¹ heating rate. After heat treatment, silver mesh current collectors were applied to both the anode and cathode of this cell. Each silver mesh current collector is interwoven with the gold leads and is attached to the respective electrode using silver paste. After the silver paste dries (for at least 20 minutes), the cell is placed on the alumina tube setup using the high-temperature sealing paste mixed with thinner, along with an alumina felt seal to make a leak-free attachment of the cell to the alumina tubing. The cell is left in the open-air environment for four or more hours (to allow for the paste to dry) and placed in the cell-testing furnace. Here, the cell undergoes in-situ heat treatment at 95° C. and 260° C. for two hours each, followed by sintering at 550° C. for an hour. The cell is then heated to 800° C. after which a 100 SCCM of 4% H₂ balanced in N2 is introduced anode-side and 100 SCCM of UHP O₂ is introduced to the cathode side. After contact with the catalyst of the claimed invention for one hour under 4% H₂, 100 SCCM UHP CH₄ is introduced to the anode side for electrochemical oxidative coupling of methane experiments. The outlet of the E-OCM set up is continuously fed into a Cirrus mass spectrometer for regular monitoring and periodically analyzed by an SRI 8610C Gas chromatography instrument. Electrochemical experiments were carried out using a Gamry reference 600 instrument.

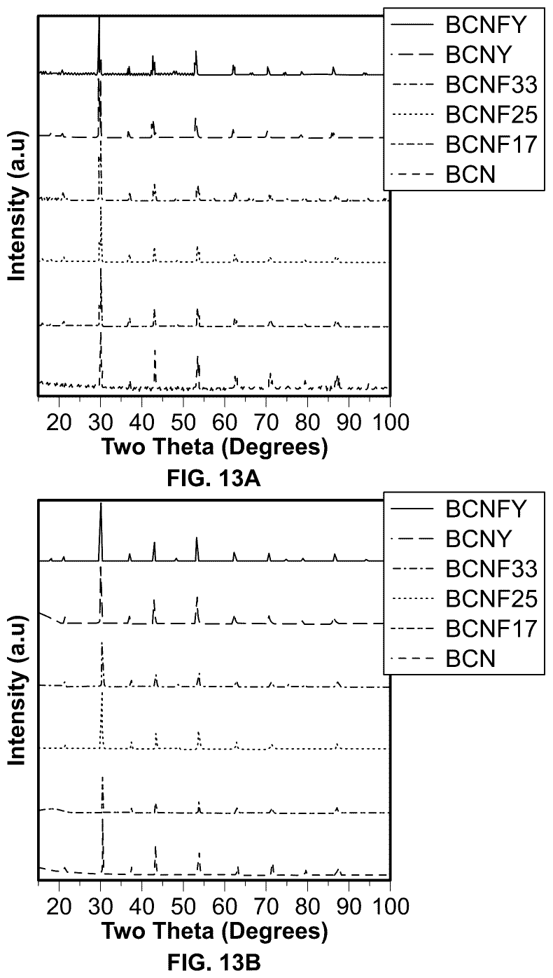

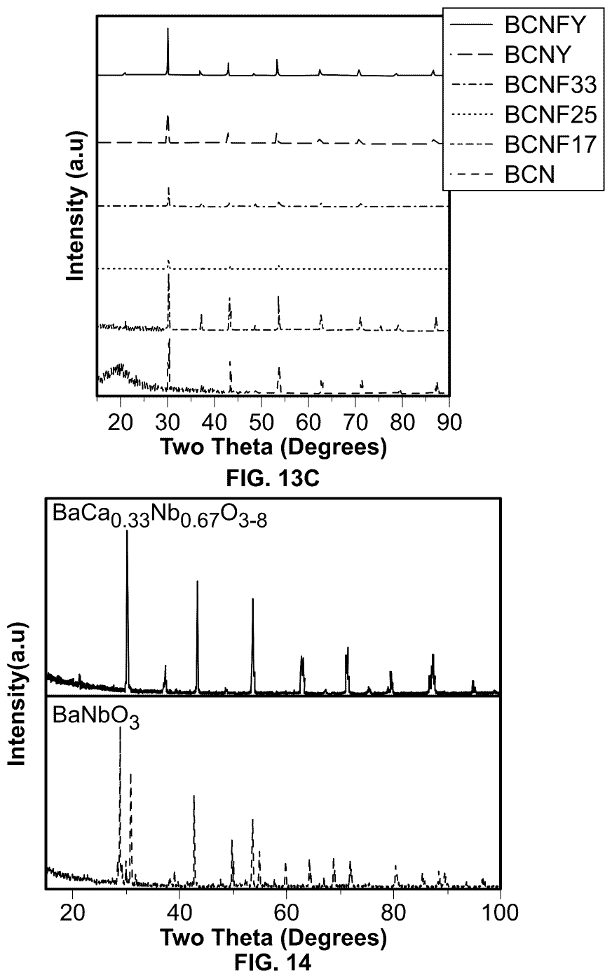

The PXRD pattern obtained for the six different compositions of Ca, Fe, and Y doped barium niobates are given in FIG. 13A. The labelling for the compositions as follows; BaCa_{0.33}Nb_{0.67-x-y}FeₓY_{y}O_{3-δ} where y=0, and x=0.17, 0.25, and 0.33 are labeled as BCNF17, BCNF25, and BCNF33 respectively, x=0, and y=0.13 as BCNY, x=0.20, y=0.13 as BCNFY, and Ca doped barium niobate with x=0, y=0 as BCN. The Goldschmidt tolerance factor for all the prepared perovskites are given in Table S1 that show tolerance numbers between 0.955 and 0.988.

TABLE S1
Goldschmidt tolerance factor value calculated for the prepared

| | Goldschmidt |
|---|---|
| Composition | Tolerance factor (t) |
| BaNbO₃(BN) | 1.023 |
| BaCa_{0.33}Nbar_{0.57}O_{3-δ} (BCN) | 0.974 |
| BaCa_{0.33}Nb_{0.47}Y_{0.13}O_{3-δ}(BCNY13) | 0.955 |
| BaCa_{0.33}Nb_{0.34}Fe_{0.20}Y_{0.15}O_{3-δ}(BCNF20Y13) | 0.973 |
| BaCa_{0.33}Nb_{0.50}Fe_{0.17}O_{3-δ}(BCNY17) | 0.984 |
| BaCa_{0.33}Nb_{0.42}Fe_{0.25}O_{3-δ}(BCNY25) | 0.988 |
| BaCa_{0.33}Nb_{0.38}FeO_{3-δ}(BCNY33) | 0.973 |

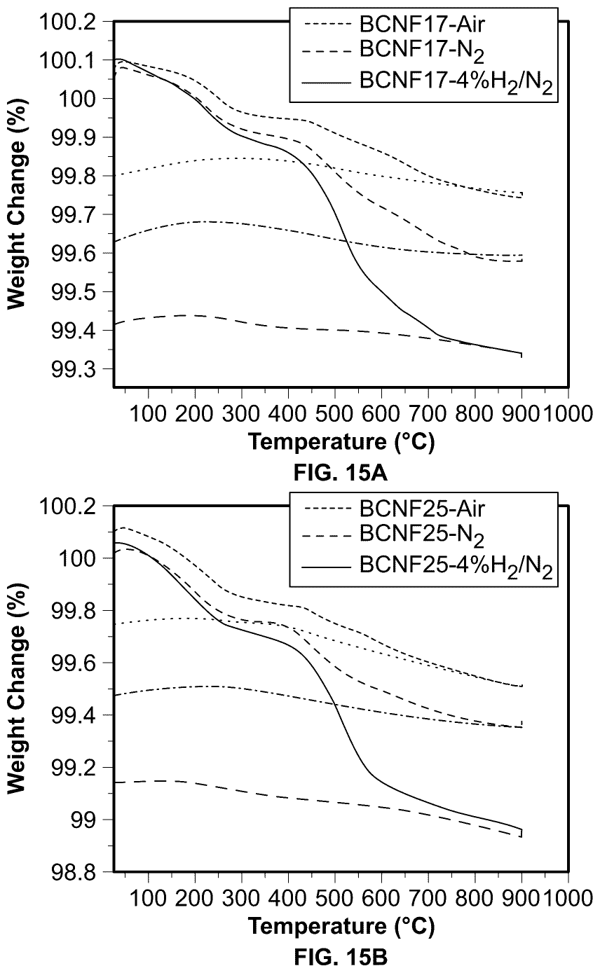

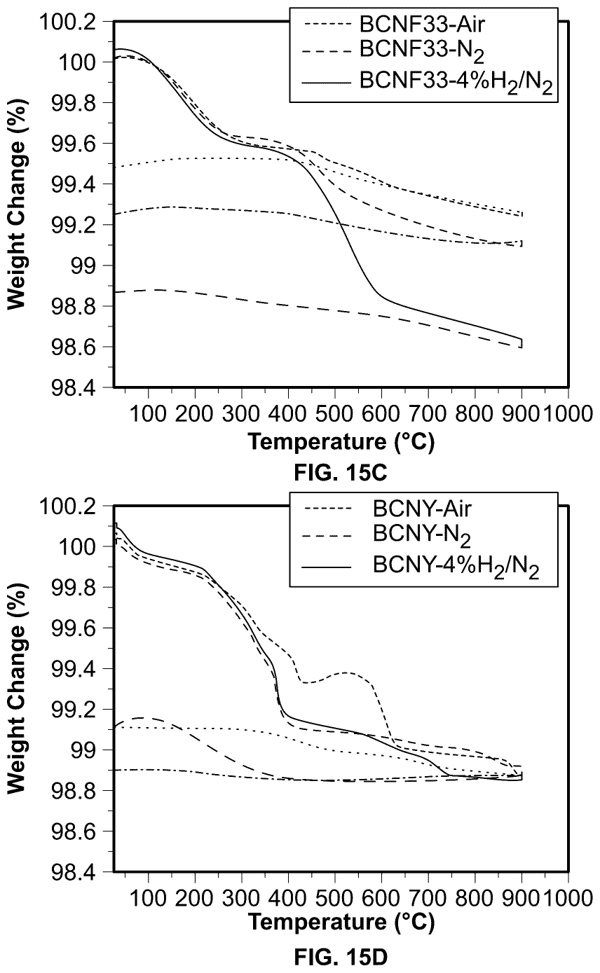

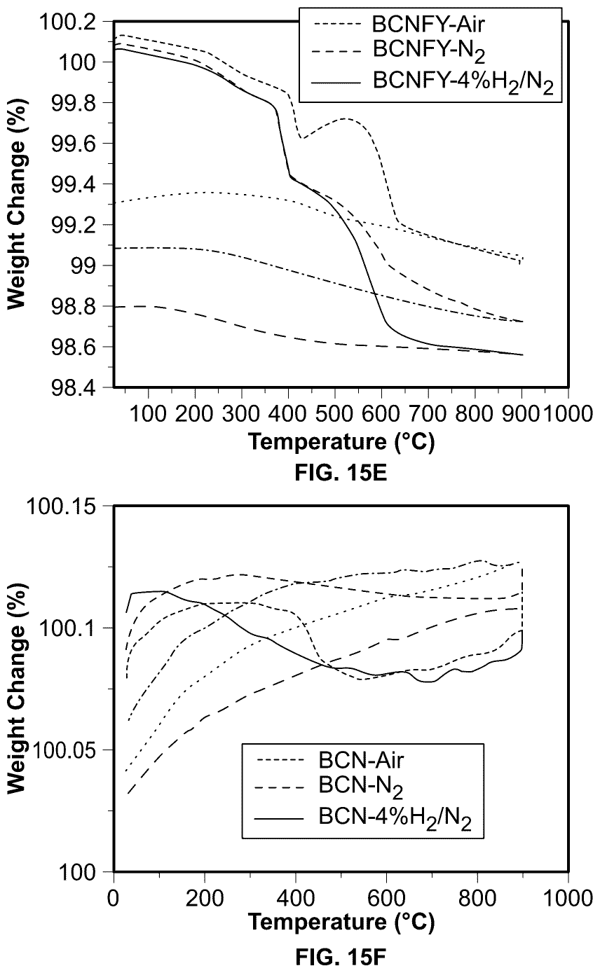

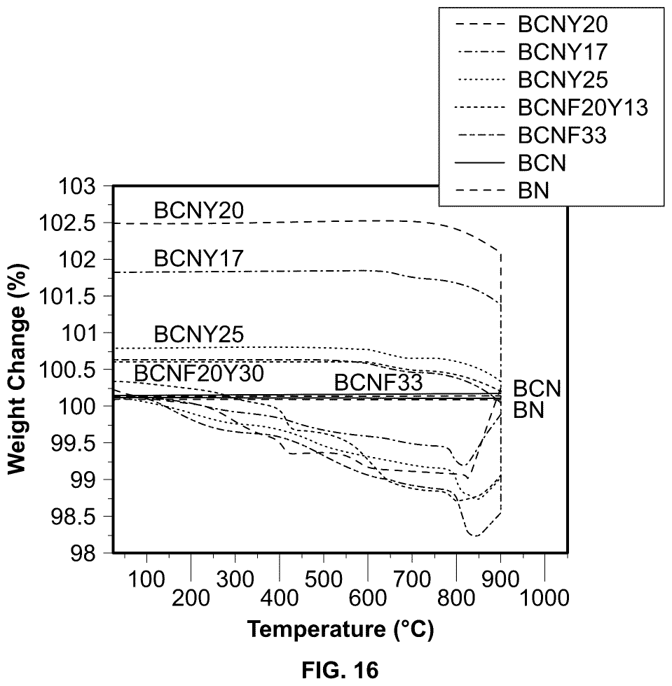

The Ca doping in the range of 0.1 to 0.5 is essential to form the perovskite structure as without Ca doping the tolerance factor is above 1 which is known to restrict the cubic perovskite structure formation. All six prepared compositions formed the face centered cubic perovskite structure in the Fm3m space group. Attempts to form the barium niobate without any dopants (tolerance number 1.024) resulted in multiple phase crystal structure (FIG. 14). However, other dopants such as Fe, Co, Y, Yb, Ni, Sc, Pr could stabilize the perovskite structure without Ca doping. TGA measurements in various environments such as air, N2, 4% H₂ balanced in N2, and pure CH₄ were carried out to understand the chemical stability of these perovskites in oxygen deficient environments. The powders were heated to 900° C. at a heating and cooling rate of 5° C. min⁻¹ and held at 900° C. for an hour. From FIGS. 15A to 15F and 16, it is clear that BCN do not show any observable change in weight during TGA in various environments while all other compositions showed measurable weight change in these measurements. In TGA under air, the weight loss increased with increasing Fe content, from 0.2% in BCNF17 to 0.6% in BCNF33. Interestingly, both Y doped perovskites, BCNY and BCNFY, showed a small weight gain between 400° C. to 600° C. that could be attributed to oxygen adsorption or insertion in the crystal lattice. TGA under N2 atmosphere do not show this weight gain in BCNY and BCNFY confirming it to be associated with oxygen insertion. All Fe containing compositions showed higher total weight loss in N2 atmosphere than in air. TGA in 4% H₂ showed that the total weight loss increases further in all Fe containing samples with increasing incorporation of Fe resulting in higher weight losses. The weight loss follows the trend air<N₂<4% H₂/N₂ in all Fe containing samples suggesting that weight loss might be associated with oxygen loss from the crystal lattice that creates oxygen vacancy. To maintain electroneutrality, the weight loss must be associated with oxidation state change in either Nb^{4+/5+} or Fe³⁺ in the lattice since Ba and Ca are not known to have variable oxidation states and a have fixed oxidation state of +2. Equation (1) to (3) indicates some of the possible reactions corresponding to the oxygen loss in Kröger-Vink notation.

$$2 {Fe}_{F e}^{x} + 3 {O}_{O}^{x} \to 2 {Fe}_{F e}^{′′′} + 3 {V}_{O}^{••} + \frac{3}{2} {O}_{2} \qquad ( 1 )$$

$$2 {Fe}_{F e}^{x} + {O}_{O}^{x} \to 2 {Fe}_{F e}^{′} + {V}_{O}^{••} + \frac{1}{2} {O}_{2} \qquad ( 2 )$$

$$2 {Nb}_{N b}^{x} + {O}_{O}^{x} \to 2 {Nb}_{N b}^{′} + {V}_{O}^{••} + \frac{1}{2} {O}_{2} \qquad ( 3 )$$

Fe_{Fe}^{x} indicates Fe³⁺ in Fe³⁺ lattice site with no net charge, and Fe_{Fe}′″ indicate Fe⁽⁰⁾ in Fe³⁺ lattice site with three negative charges, and V_{O}^{••} indicate a vacancy in oxygen lattice site with two positive charges etc. The assumption is that Fe is in its highest possible oxidation state +3 and Nb stays as a mixture of +4 and +5 in the prepared samples. Eq (1) show the complete reduction of Fe³⁺ to Fe⁰ while eq (2) show the reduction of Fe³⁺ to Fe²⁺ and eq (3) show the reduction of Nb⁵⁺ to Nb⁴⁺. PXRD analysis obtained for the 4% H₂/N₂ treated samples as shown in FIG. 13B retain the perovskite structure and do not show any additional peaks suggesting lack of crystal structure collapse or transformation. PXRD further reveal an increase in lattice constant in Fe doped compounds as shown in Table S2 that supports a partial reduction of either Fe³⁺ or Nb⁵⁺ as per equations (2) and (3).

TABLE 52
Lattice constant values obtained for all the as prepared
perovskites and after exposure to 4% H₂/N₂, and CH₄

| Material | As prepared (Å) | 4% H2 treated (Å) | CH4 treated (Å) |
|---|---|---|---|
| BCN | 8.3443 | 8.3420 | 8.3468 |
| BCNF17 | 8.3750 | 8.3805 | 8.3808 |
| BCNE25 | 8.3776 | 8.3786 | 8.3734 |
| BCNF33 | 8.3740 | 8.3755 | 8.3684 |
| BCNFY | 8.4237 | 8.4332 | 8.4205 |
| BCNY | 8.4522 | 8.4478 | 8.4270 |

In BCNY, there is no further increase in total weight loss when the atmosphere is switched from air to N₂ or to 4% H₂/N₂ clearly suggesting that Fe and Nb might act synergistically when oxygen vacancies created while Y is non-interacting with Nb. There is no reliably quantifiable weight change in BCN indicating that Ca doping is primarily to stabilize the barium niobate in cubic perovskite. TGA in pure methane environment reveal a slight weight gain of about 2% for all Y and Fe doped compositions indicating possible carbon deposition. PXRD obtained after methane exposure however do not reveal any peaks associated with carbon or carbonate formation and retained the perovskite structure suggesting that the perovskites are chemically stable and any carbon formation may be kinetically sluggish (FIG. 13C). A similar experiment with SFMO resulted in 40 to 60% weight gain and complete collapse of the crystal structure.

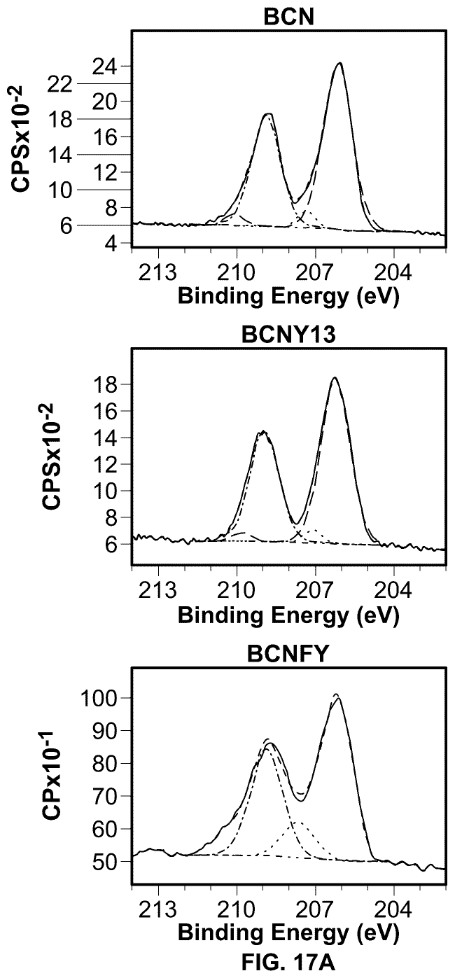

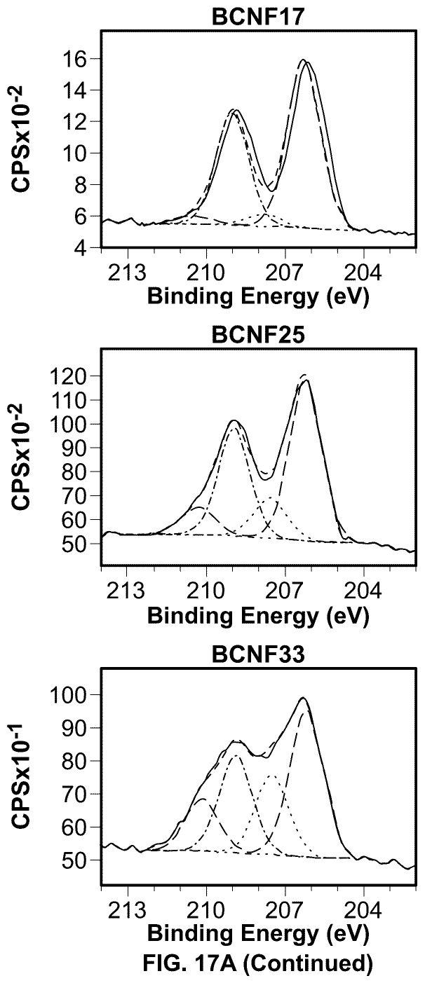

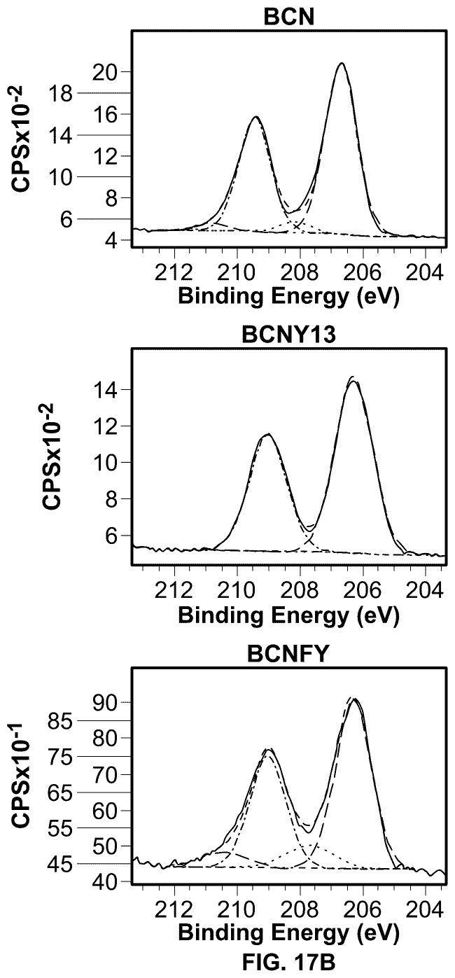

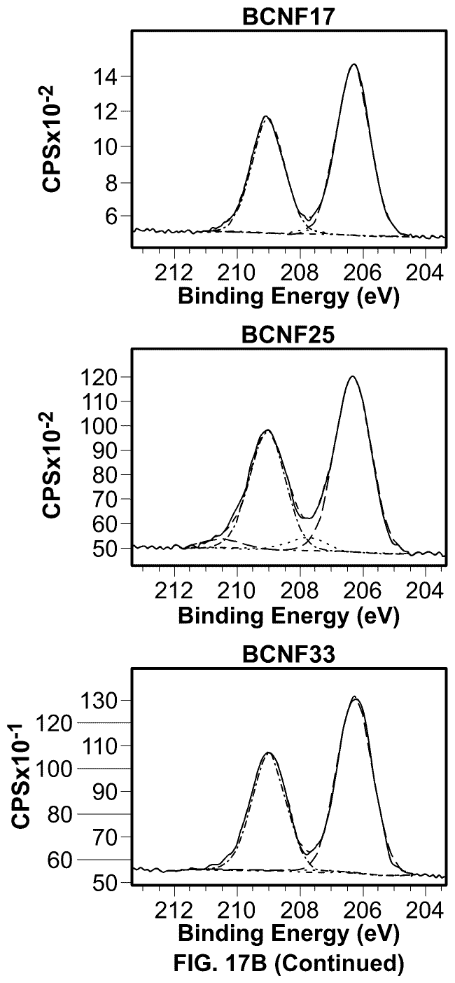

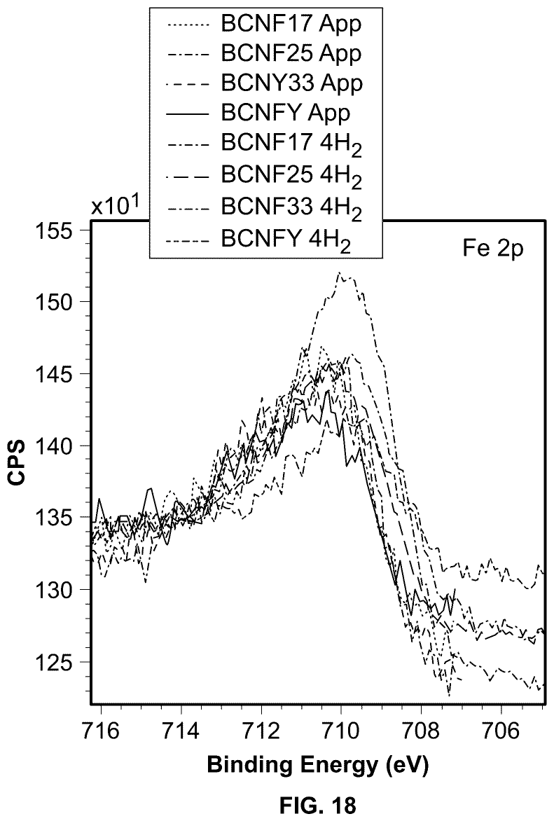

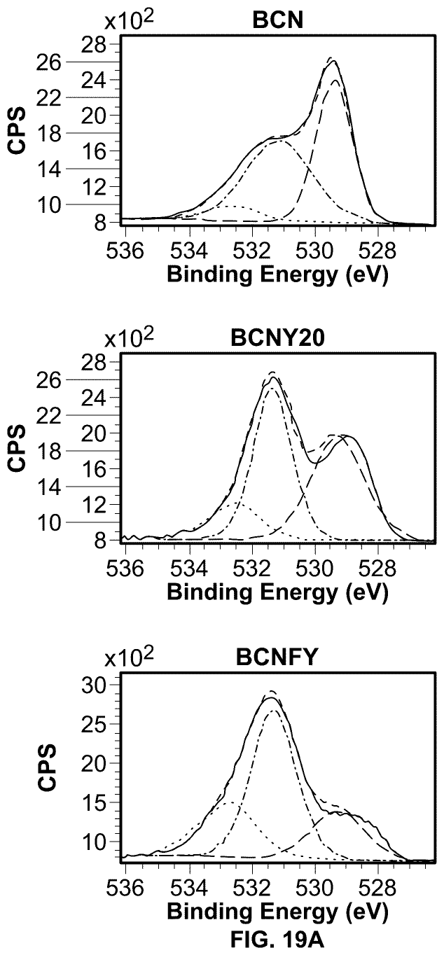

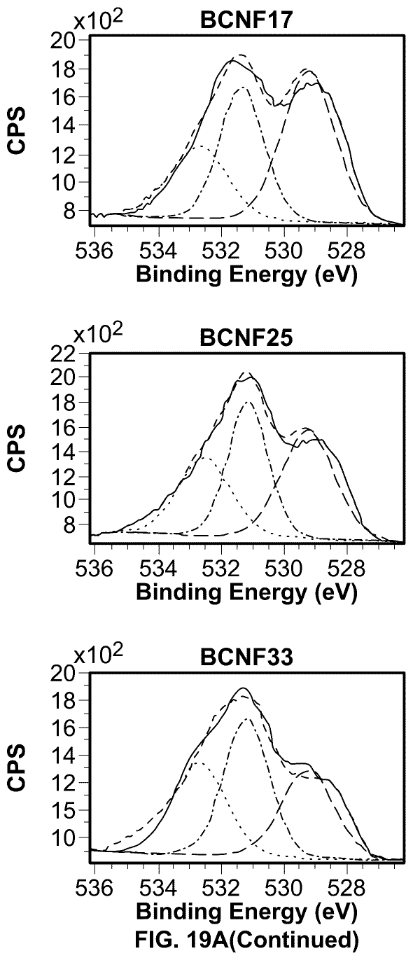

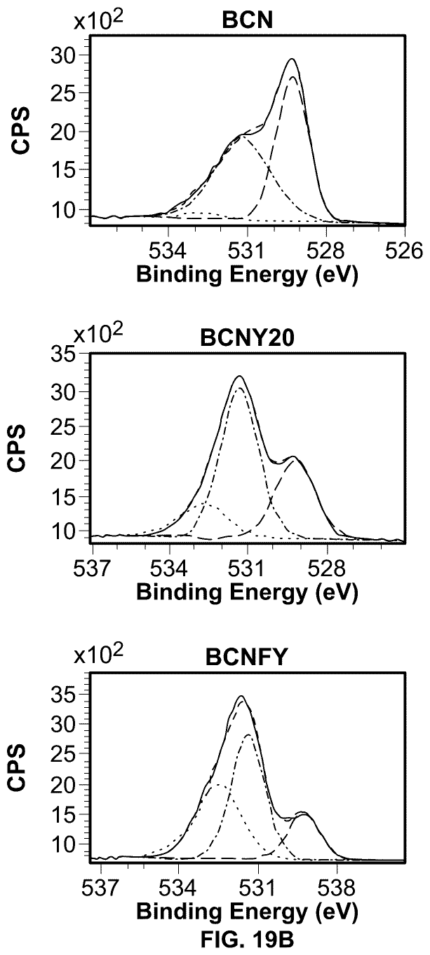

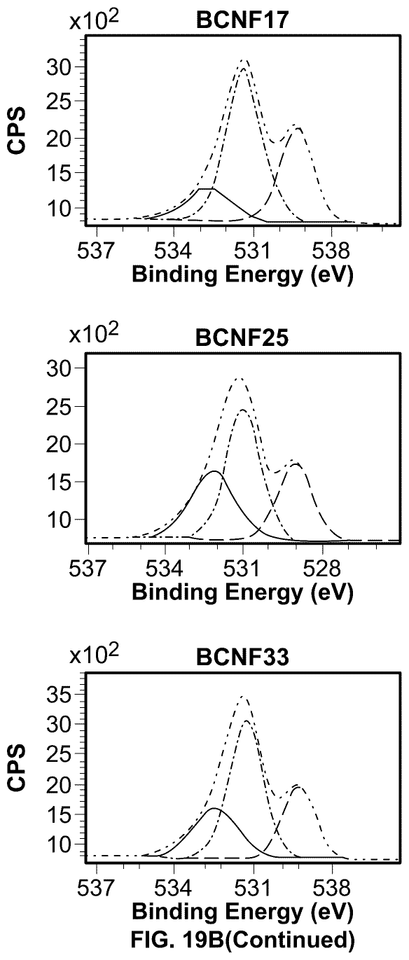

The weight loss under 4% H₂/N₂ can be attributed to the loss of oxygen and creation of oxygen vacancy. However, such vacancy creation must be supported by either a reduction in oxidation state of the metal cations or complete metal exsolutions. In the prepared perovskites possible reactions to support the oxygen vacancy creation is given in equations (1)-(3). To observe any changes in the oxidation state of metal cations, XPS measurements were carried out on the prepared perovskites and after exposure to 4% H₂/N₂. FIG. 17A show the XPS Nb 3d peaks obtained for the as prepared samples. BCN and BCNY show the lowest contribution of Nb⁵⁺ while Nb⁵⁺ contribution increases with increasing Fe doping with BCNF33 show a maximum Nb⁵⁺ contribution of 35.07%. However, in samples after 4% H₂/N₂ exposure, there is clear shift from Nb⁵⁺ to Nb⁴⁺. XPS measurements for Fe 2p (FIG. 18) show that Fe remained in the 3+ oxidation state before and after exposure to 4% H₂/N₂ and hence, all oxidation state changes occurred are on Nb. However, in the case of Ca and Y as dopants such as BCN and BCNY, the shift from Nb⁵⁺ to Nb⁴⁺ were minimal. Similarly, XPS O1s measurements given in FIG. 19 show that there is a marked increase in the peak at 531-532 eV with increasing Fe content as well as after 4% H₂/N₂ treatment. This peak is often falsely associated with oxygen vacancies but is observed to be due to surface oxygen atoms passivated with hydrogen and hydroxyl groups in the lattice oxygen sites. Both of these processes require vacancy creation to maintain electroneutrality.

Table S3 shows the Nb4+ and Nb5+ concentrations on the as prepared and 4% H2/N2 treated samples obtained by XPS measurements.

TABLE S3
Nb4+ and Nb5+ concentrations on the as prepared and
4% H2/N2 treated samples obtained by XPS measurements.

| | |
|---|---|
| As prepared | 4% H2/N2 treated |

| Sample | Nb4+ | Nb5+ | Nb4+ | Nb5+ |
|---|---|---|---|---|
| BCN | 94.55 | 5.45 | 94.84 | 5.46 |
| BCNY | 95.52 | 4.48 | 99.60 | 0.40 |
| BCNFY | 81.96 | 18.04 | 84.97 | 15.03 |
| BCNF17 | 93.33 | 6.67 | 98.53 | 1.47 |
| BCNF25 | 79.41 | 20.59 | 93.01 | 6.99 |
| BCNF33 | 64.93 | 35.07 | 96.32 | 3.68 |

Since there is quantifiable change observed in the concentrations of Nb⁴⁺ and Nb⁵⁺ between the as prepared samples and 4% H₂/N₂ treated samples in XPS, the possible net generation of Fe⁽⁰⁾, Fe²⁺ and Nb⁴⁺ as per equations (1) to (3) was calculated from the TGA data (see supporting information for calculation, and Table S4).

TABLE S4
Potential concentration of reductions products due to oxygen loss
under 4% H2/N2 calculated as per the equations (1), (2), and (3)
and Nb4+/5+ contribution change observed in XPS measurements.

| | | | | From XPS |
|---|---|---|---|---|
| Sample | 3O = 2Fe(0) | O = 2Fe(2+) | O = 2Nb(4+) | (Nb^{4+/5+}) |
| BCN | 0.4 | 1.3 | 1.3 | >1% |
| BCNF17 | 4.6 | 13.9 | 13.9 | 5.2 |
| BCNF25 | 5.5 | 16.5 | 16.5 | 13.6 |
| BCNF33 | 5.3 | 15.4 | 15.4 | 31.39 |

The calculated values follows the trend observed from XPS for these samples once again indicating that all charge neutrality requirements due to oxygen vacancy creation has been compensated mostly by the Nb⁵⁺ to Nb⁴⁺ change. It also underlines the reason for the observed stability of the perovskite structure under these reducing conditions. However, the surface passivation of oxygen sites with hydrogen or hydroxyl groups complicates the calculation and could explain the small discrepancies between values derived from XPS and TGA.

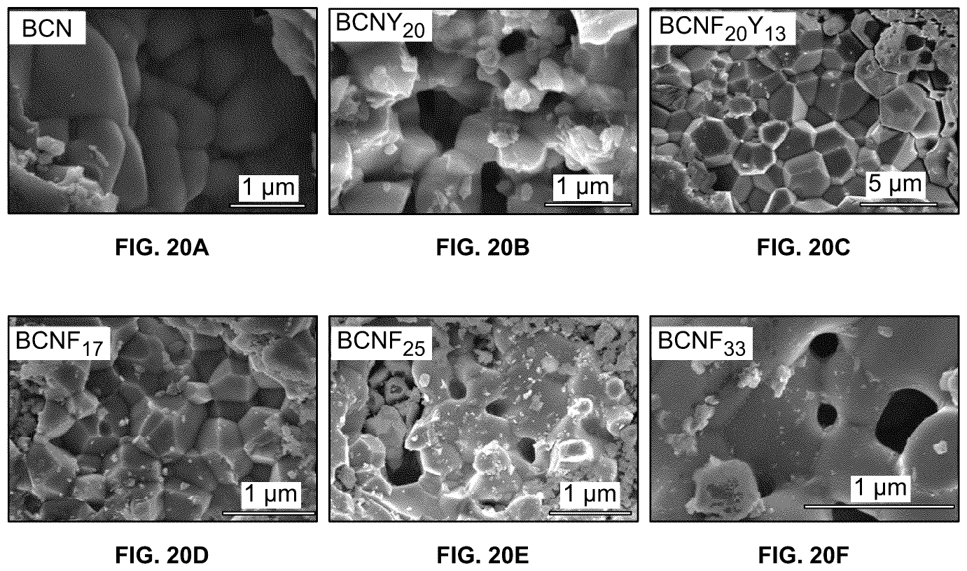

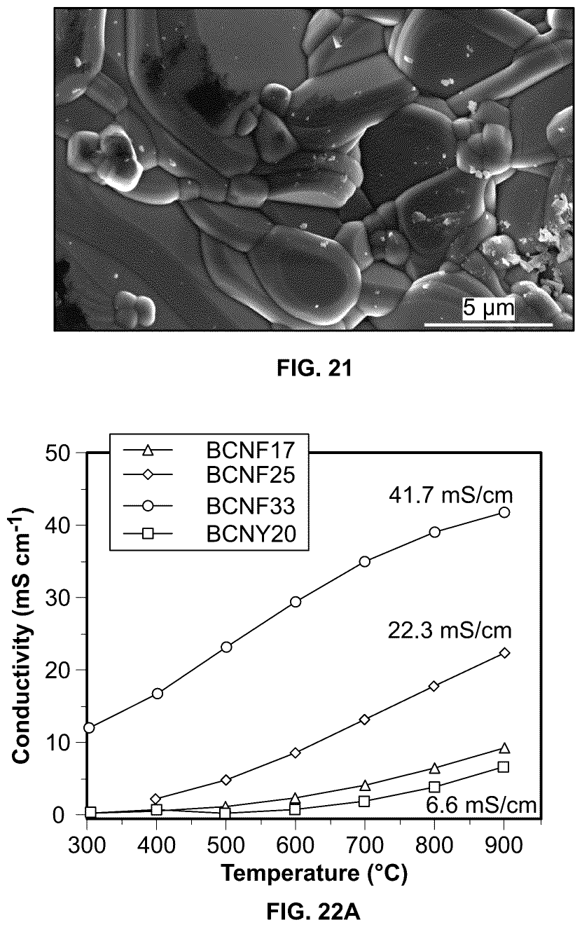

The microstructure of the as prepared perovskite pellets obtained by SEM micrographs is given in FIG. 20. The pellets were polished and ultrasonicated in acetone followed by drying at 100° C. in an oven. BCN has formed a dense pellet with grain size in the range of 0.5-1 μm. Y doped BCNs (BCNY and BCNFY) show visible porosity with comparatively smaller grain sizes. Y doped BCNs have been reported to fully sinter only at very high temperatures such as 1550° C. hence the observed high porosity is not surprising after sintering at 1400° C. Introduction of Fe helps sinter the pellets and form bigger grains with well-defined edges. However, the porosity increases with increasing Fe doping and the hardness of the pellets decrease. SEM micrographs of undoped barium niobate pellets showed grains of vastly varying sizes and shapes that indicate constrained growth of different crystallite phases (FIG. 21).

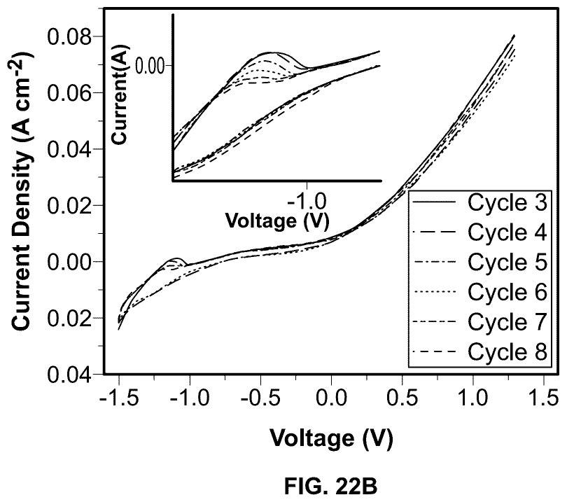

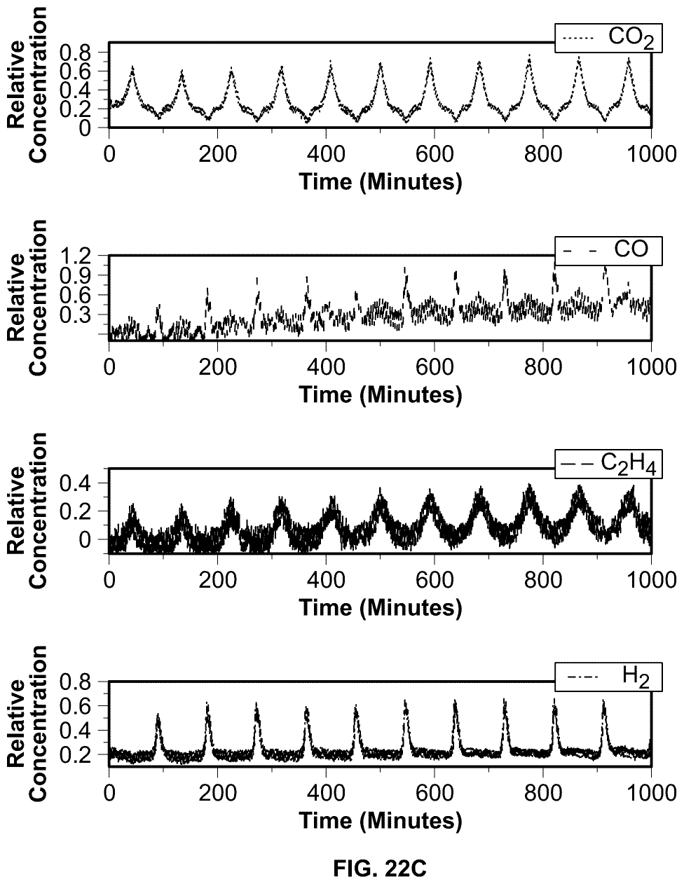

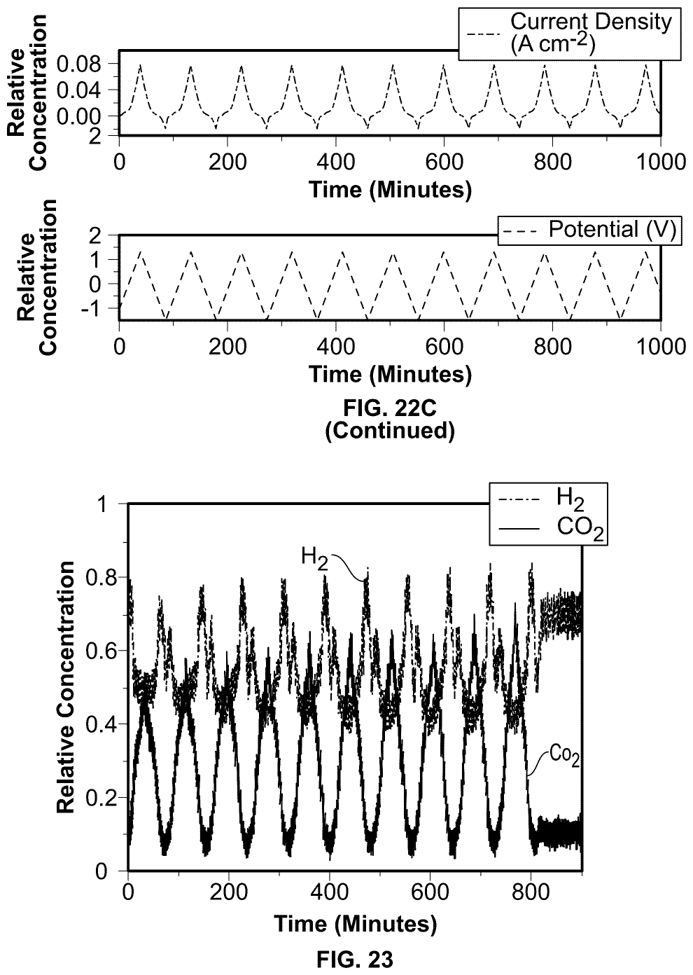

Electrical conductivity values of the pellets obtained by impedance measurements in atmospheric air in the temperature range of 300° C. to 900° C. is given in FIG. 22A. Both undoped barium niobate and BCN did not show any significant conductivity values and hence were not shown here. However, the introduction of both Y and Fe dopants induce improved electrical conductivity. BCNY showing a maximum conductivity of 6.6 mScm⁻ at 900° C. Incorporation of Fe seem to induce maximum conductivity and BCNF33 showed the highest value of 41.7 mS cm⁻ at 900° C. For comparison, the Mg and Fe codoped compound, BMNF33 showed only 17 mScm⁻ at this temperature indicating that the higher ionic radii of Ca may help induce higher conductivity. However, the crystallographic arrangement is also different between BCNF and BMNF as the BCNF has the Fm-3m space group while BMNF is Pm3m, which could also play a role in changing the electrical properties. Cyclic voltammetry plots obtained at 850° C. utilizing BCNF25 as the anode, LSM as the cathode, and 800 μm thick LSGM as electrolyte is given in FIG. 22B. Pure methane was supplied to the anode while the cathode was exposed to air with a scanning rate of 1 mV s⁻¹. The open circuit voltage obtained was −1.01 V. Air electrode was utilized as the reference electrode since the methane supplied anode is not a reliable reference electrode. The mass spectroscopic analysis of the outlet stream in parallel to applied potential and current as a function of time is given in FIG. 22C. An oxidative peak near −1.0 V was observed along with a continues increase in anodic current between 0.0 to 1.25 V. Both these anodic currents are associated with a change in the product stream combinations. The rise in current density around −1.0 V results CO and H₂ generation while the rise in current density between 0.0 to 1.25 V results in significant ethylene and CO₂ generation. No quantifiable ethylene is observed around −1.0 V while a very small CO production is observed between 0.0 and 1.25 V indicating a preferential potential window for both these products. Water was condensed out from the product stream before it entered the mass spectrometer and hence data on its production as a function of applied bias is not available. A previous study using BMNF perovskites showed only the production of ethylene and CO₂ at 1.0 V and no CO was observed during the measurement. A maximum ethylene production rate of 154 μmol cm⁻² h⁻¹ at a faradaic efficiency (FE) of 21% while the FE for CO₂ production is 45%. The C₂H₄ FE was about four times higher than that obtained with SFMO based catalysts at this potential. BMNF25 showed a similar FE but at an operating temperature of 925° C. Techno-economic analysis of various ethylene production methods such as ethane dehydrogenation (EDH), OCM and E-OCM are carried out recently that utilize 1.6 V as the E-OCM operating potential. The study showed an $884 per metric ton ethylene production from EDH and $1399 for E-OCM and recommends catalysts that can operate at a lower applied bias would be beneficial to bring that cost down further.

The catalysts and methods of the present invention show very good ethylene production at 1.25 V indicating potential benefits for E-OCM processes. E-OCM experiments with BCNF33 resulted in complete oxidation product CO₂ with only trace amounts of ethylene (FIG. 23) while experiments with other compositions did not result in significant current due to their low electrical conductivity.

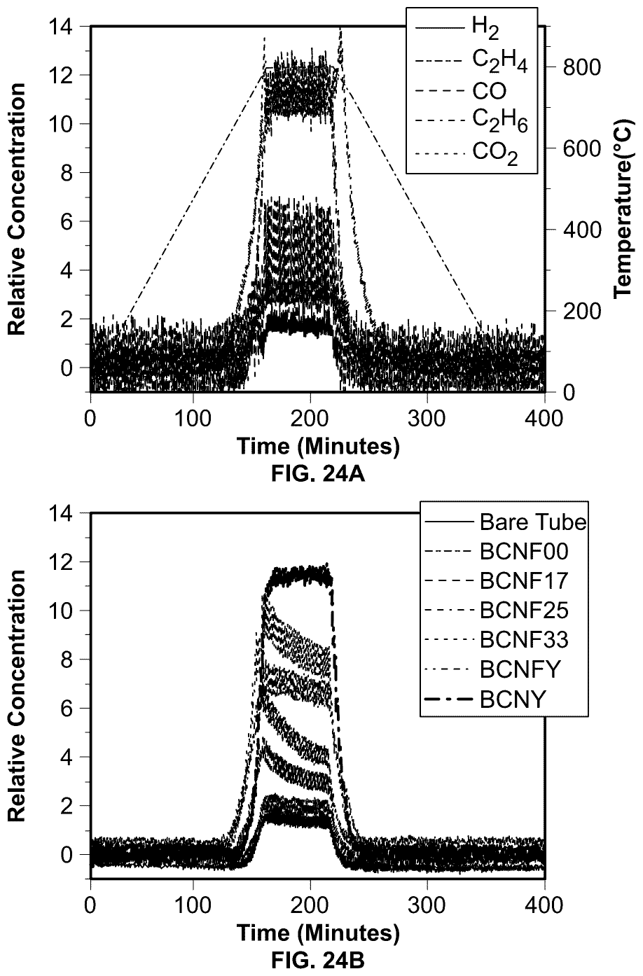

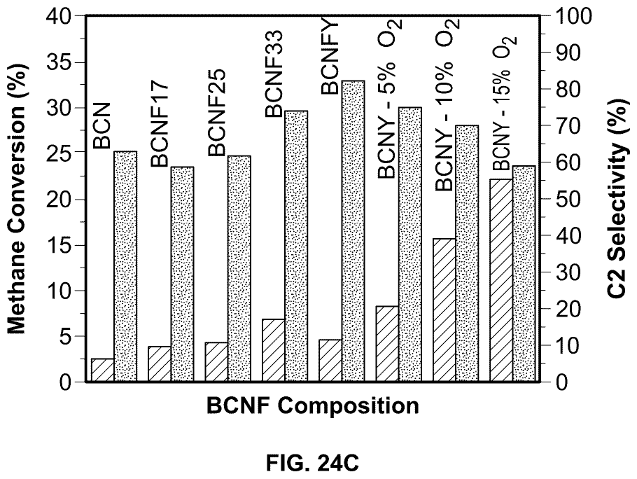

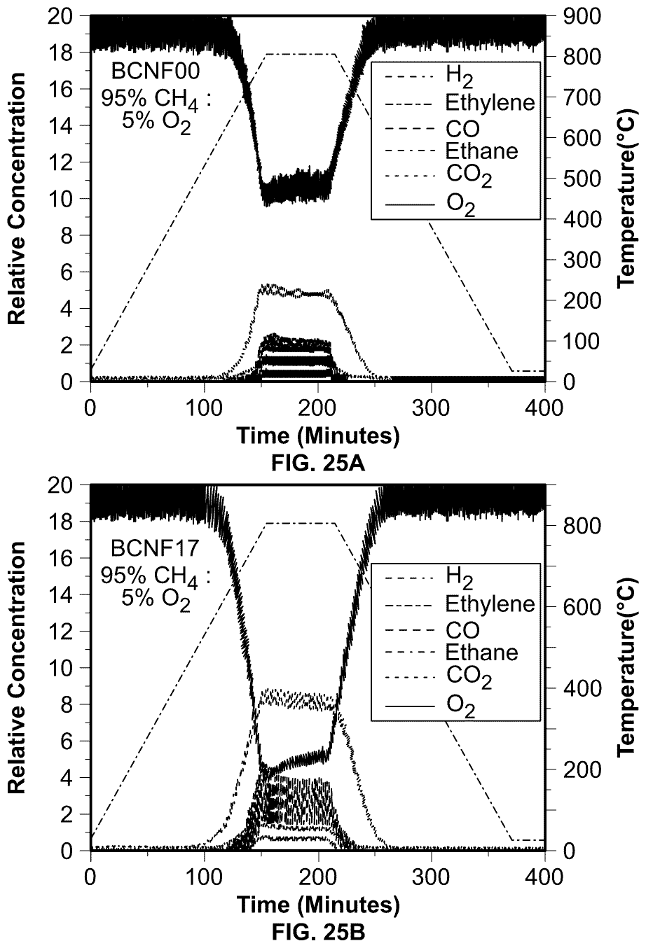

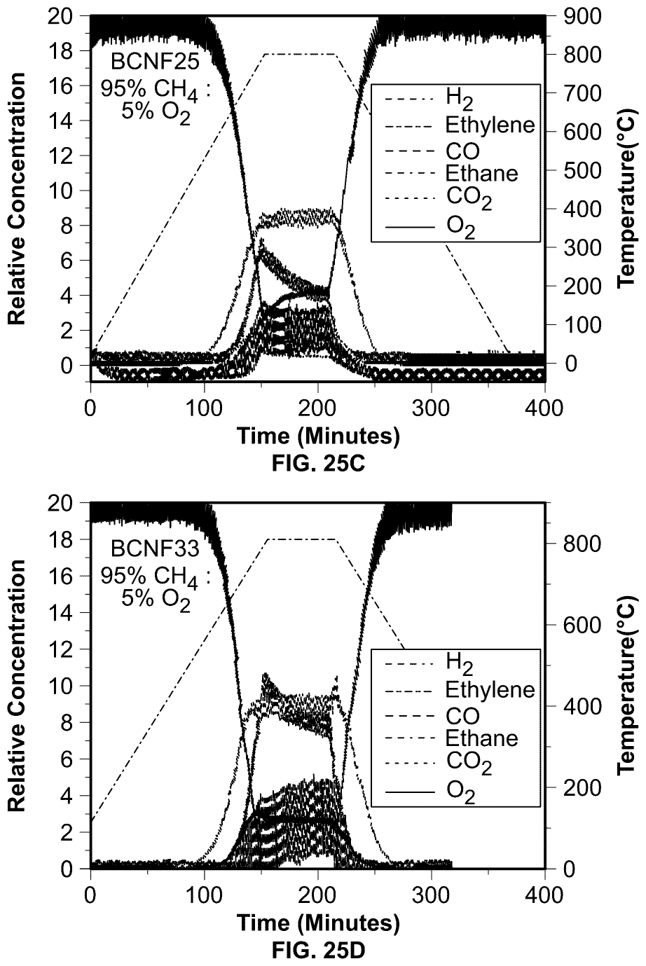

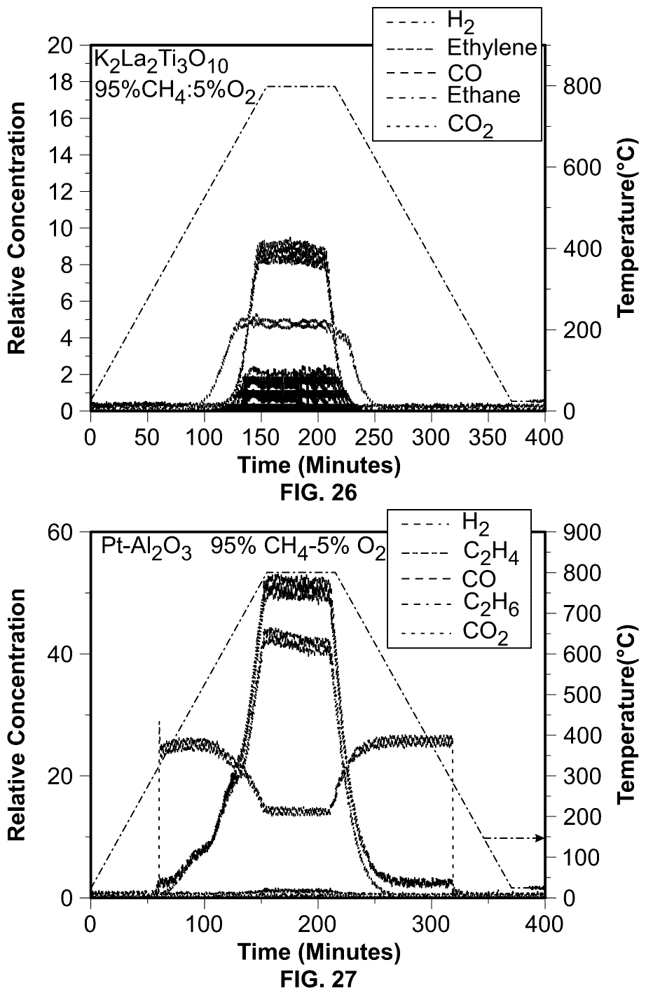

Temperature programmed reaction under 95% CH₄ and 5% O₂ was carried out in the temperature range of 25 to 800° C. and held for an hour. 50 mg of the perovskite powder was mixed with 100 mg of Silicon carbide and held in place inside an alumina tube (inner diameter—6.2 mm) by quartz wool. Mass spectroscopic observation of the outlet stream as a function of time and temperature is given in FIG. 24A and FIG. 25. Methane activation towards CO₂ is observed from 450° C. while ethylene, ethane, and CO production starts at 600° C. H₂ is the other observed product while H₂O is condensed out and we did not quantify it due to partial condensation in the lines. The oxygen consumption increases with increasing Fe content and complete oxygen utilization is observed for BCNF33, BCNFY and BCNY (FIG. 25). FIG. 24B shows that ethylene production increases with increasing Fe content in perovskite while BCN show ethylene production rates comparable to that of bare tube measurements where 100 mg of silicon carbide was utilized with no perovskite powder. BCNFY has 20% Fe doping along with 13% Y doping that show ethylene production better than BCNF25 and also show the least degradation in performance among Fe containing catalysts indicating that Y also plays an important role in stabilizing the catalytic activity. However, BCNY with no Fe doping showed the highest methane conversion among all the tested catalysts and a C2 selectivity of 75%. For comparison, K₂La₂Ti₃O₁₀ (KLT), a layered perovskite that has previously been reported to show good OCM performance was prepared. KLT show a similar C2 selectivity of 74% but methane conversion is only 6.6%. Under similar conditions, BCNF33 and BCNFY show very similar OCM performance while BCNY show better conversion than KLT (9%). Commercial 1% Pt/Al₂O₃ catalyst was also evaluated for comparison under similar conditions and the result is shown in FIG. 26. Complete oxygen consumption was observed at 325° C. with CO₂ as the major product. However, at temperature above 550° C., the CO and H₂ concentration increases at the expense of CO₂ due to dry reformation (CH₄+CO₂=CO+H₂). Only a trace amount of C₂ hydrocarbons observed during this measurement. Since, BCNY showed the maximum conversion with about 76% C2 selectivity, we increased the oxygen concentration from 5% to 10 and 15% and the conversion increased from about 9% to 15% and 22% respectively while maintaining C2 selectivity above 60%. With increasing oxygen concentration, a small amount of CO is also observed in the product stream.

Perovskite with increased Y doping, BCNY20 showed better OCM performance with a maximum conversion of 45% and C2 selectivity of 76% was achieved. The above results indicate that the Ca doping is essential to stabilize the barium niobate in cubic FM3M crystal structure. However, Ca doping does not induce any oxygen mobility as evidenced from TGA, electrical conductivity and TPR measurements. Fe doping in BCN induce oxygen mobility and better electrical conductivity that leads to methane activation properties. However, under reducing conditions, there is an increasing loss in lattice oxygen that results in catalytic activity loss. Y doped BCNY showed better and durable catalytic activity than BCNFs in TPR measurements while showing no weight loss under reducing conditions in TGA showing that lattice oxygen may play a bigger role in methane activation.

Ca, Fe, and Y codoped barium niobates were successfully prepared in the cubic perovskite structure and analyzed for methane activation and conversion towards ethylene in both E-OCM and OCM setup. TGA measurements in air, N₂, 4% H₂/N₂ environments coupled with XPS analysis revealed that Fe and Nb exist in synergy in the crystal lattice to maintain the perovskite structure under reducing conditions. In electrical conductivity measurements, BCNF33 showed a maximum conductivity of 41.7 mS cm⁻ at 900° C. E-OCM measurements carried out at 850° C. showed a potential dependent product selectivity between CO and ethylene and also showed durable performance over 15 hours of continuous operation. A maximum ethylene production rate of 154 μmol cm⁻² h⁻¹ at a faradaic efficiency (FE) of 21% was achieved under E-OCM measurements

### Experimental

Materials: BaCO₃, CaCO₃, Nb₂O₅, Fe₂O₃, Y₂O₃, LSGM, GDC, K₂CO₃, La₂O₃, TiO₂, and Ag wire were all procured from Millipore Sigma®. Ag mesh current collectors, high temperature sealing paste (CAP552), thinner (CAP552-T), and alumina slurry (ALSL) were purchased from Fuel Cell Materials Inc. Alumina tubes were purchased AdValue Technology.

### Material Synthesis

All perovskite materials were prepared by solid-state synthesis methods. The metal oxide and metal carbonate precursors were weighed in stoichiometric rations to produce 7 g of BaCa_{0.33}Nb_{0.67-x-y}FeₓY_{y}O_{3-δ} with y=0, and x values of 0.17 (BCNF17), 0.25 (BCNF25), 0.33 (BCNF33), x=0.20 and y=0.13 (BCNFY), and x=0, and y=0.20 (BCNY). The precursors were mixed with 30 mL isopropyl alcohol (IPA) and ball milled in a zirconia milling jar for 6 hours followed by drying at 70° C. in an air oven overnight. The dried powders were sintered at 1000° C. for 24 hours before being ball milled and dried again as described above. 900 mg of thus obtained powders were pressed uniaxially into pellets using a 15 mm die at 1000 psi for 3 min. These pellets were placed in a nitrile glove and isostatically pressed at 240 MPa for 3 min. These pellets were placed in an alumina crucible, soaked in excess parent powder, and calcined at 1400° C. for 24 hours with a heating and cooling rate of 3° C. min⁻¹ in a Carbolite tube furnace. LSGM pellets for electrolyte application were prepared from commercially obtained LSGM powder. About 1.6 g of LSGM powder was pressed uniaxially using a 25 mm die. The pressed powder was then pressed in the isostatic press at 240 MPa for 3 min followed by sintering at 1300° C. for 24 h using a 3° C. min⁻¹ heating and cooling rate. K2La2Ti3O10 (KLT) layered perovskite metal oxide was prepared via conventional solid-state synthesis utilizing stoichiometric amounts of its precursor oxides and carbonates by ball milling at 2500 RPM for 6 hours in 30 mL of IPA followed by drying overnight. An additional 30 wt % K2CO3 was added to the dried mixture to prevent K evaporation during sintering at 1050° C. for 24 h. Excess K₂CO₃ was removed by centrifuging in water.

### Physical Characterization:

As prepared perovskite powders were characterized by PXRD, TGA, SEM, and XPS measurements. TGA measurements were carried out using TA Q600 SDT instrument in air, N₂, 4% H₂/N₂, and pure CH₄ conditions with a flow rate of 25 mL min⁻¹ in the temperature range of 25 to 900° C. at a heating and cooling rate of 5° C. min⁻¹ and held at 900° C. for an hour. XPS measurements were performed on a Kratos Ultra DLD spectrometer using a monochromatic Al Kα source operating at 150 W (1486.6 eV). The operating pressure was 5×10⁻⁹ Torr. Survey spectra were acquired at a pass energy of 160 eV and high-resolution spectra were acquired at a pass energy of 20 eV. XPS data were processed using Casa XPS software. X-ray diffraction measurements were done in a PANalytical Xpert Pro instrument using Cu Kα radiation and operating at 40 kV and 40 mA on a zero-background holder. SEM measurements carried out on Hitachi S-5200 scanning electron microscope. Mass spectroscopic measurements were carried out using MKS Cirrus 2 Mass Spectrometer.

### Electrochemical Measurements:

Electrical conductivity measurements were carried out on the pellets by polishing them first followed by sputtering Au on both sides (20 nm). Au ink was brush painted on top of this and sintered at 800° C. for 2 hours. These pellets were placed between two gold foils in a homemade set up and electrochemical impedance measurements were carried out in the frequency range of 1 MHz to 0.1 Hz with an amplitude of 25 mV. For E-OCM measurements, LSGM was used as the electrolyte. Anode inks were prepared by mixing BCNF (200 mg) with GDC (100 mg), terpineol (620 mg), and cellulose (70 mg) by probe sonication to produce 1 g of anode ink that was brush painted on the LSGM electrolyte with a catalyst loading of 5 mg cm⁻². Similarly, 1 g LSM ink was prepared similarly and brush painted on the other side of LSGM to form the cathode. The cell was heat-treated at 1175° C. for 12 hours at a heating and cooling rate of 3° C. min⁻¹. Silver mesh current collectors connected with silver wires were applied to both the anode and cathode of this cell using silver paste. The cell was placed on a homemade alumina tube test setup using the high-temperature sealing paste mixed with thinner, along with an alumina felt seal to make a leak-free attachment of the cell to the alumina tubing. The cell was left in the open-air environment for 4 or more hours (to allow for the paste to dry) and placed in the cell-testing furnace. Here, the cell undergoes in situ heat treatment at 95 and 260° C. for 2 h each, followed by sintering at 550° C. for 1 h. The cell was then heated to 800° C. after which a 50 SCCM of 4% H₂ balanced in N₂ was introduced anode-side and 100 SCCM of UHP O₂ was introduced to the cathode side. After 1 h under 4% H₂, 50 SCCM UHP CH₄ was introduced to the anode side for electrochemical oxidative coupling of methane experiments. The outlet of the E-OCM set up was continuously fed into a Cirrus2 mass spectrometer for regular monitoring of the products. All electrochemical experiments were carried out using a Gamry reference 600 instrument.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A catalyst comprising: a barium niobate-based perovskite structure where an alkaline earth element (Ae) has been used to dope the niobium sites and said barium niobate-based perovskite structure has the chemical formula of Ba(Ae)ₚNb_{0.67-x}MₓO_{3-δ} and Ba(Ae)ₚ Nb_{0.67-x}MₓO_{3-δ} where Ae is one of the alkaline earth element such as Mg, Ca, or Sr and M is one or more of Fe, Co, Ni, Y, Yb, W, Ta, or Pr and the M content is varied from x=0 to x=0.33 and p is varied from p=0 to p=0.50.

2. The catalyst of claim 1 wherein said alkaline earth element is Mg.

3. The catalyst of claim 1 wherein said alkaline earth element is Ca.

4. The catalyst of claim 1 wherein said alkaline earth element is Sr.

5. The catalyst of claim 1 wherein said alkaline earth element is Mg, Ca or Sr.

6. The catalyst of claim 1 wherein said alkaline earth element is one or combinations of Mg, Ca or Sr.

7. A catalyst comprising: a barium niobate-based perovskite structure where an alkaline earth element has been used to dope the niobium sites and said barium niobate-based perovskite structure has the chemical formula of Ba(Ae)ₚNb_{0.67-x}MₓO_{3-δ} and Ba(Ae)ₚ Nb_{0.67-x}MₓO_{3-δ} where M is one or more of Fe, Co, Ni, Y, or Pr and the M content is varied from x=0 to x=0.60 and p is varied from p=0 to p=0.50.

8. The catalyst of claim 7 wherein said alkaline earth element is Mg.

9. The catalyst of claim 7 wherein said alkaline earth element is Ca.

10. The catalyst of claim 7 wherein said alkaline earth element is Sr.

11. The catalyst of claim 7 wherein said alkaline earth element is Mg, Ca, and Sr.

12. The catalyst of claim 7 wherein said alkaline earth element is one or combinations of Mg, Ca or Sr.

13. A catalyst comprising: a barium niobate-based perovskite structure where an alkaline earth element has been used to dope the barium sites and said barium niobate-based perovskite structure has the chemical formula of Ba₁₋ₚ(Ae)ₚNb_{0.67-x}MₓO_{3-δ} and Ba(Ae)ₚ Nb_{0.67-x}MₓO_{3-δ} where M is one or more of Fe, Co, Ni, Y, or Pr and the M content is varied from x=0 to x=0.60 and p is varied from p=0 to p=0.50.

14. The catalyst of claim 13 wherein said alkaline earth element is Mg.

15. The catalyst of claim 13 wherein said alkaline earth element is Ca.

16. The catalyst of claim 13 wherein said alkaline earth element is Sr.

17. The catalyst of claim 13 wherein said alkaline earth element is Mg, Ca, and Sr.

18. The catalyst of claim 13 wherein said alkaline earth element is one or combinations of Mg, Ca or Sr.

19. A catalyst comprising: a barium niobate-based perovskite structure where, Mg and Ca has been used to dope the niobium sites along with Fe, Ni, Co, Y, Yb, and Pr.

20. The catalyst of claim 19 wherein said barium niobate-based perovskite structure has the chemical formula of BaCa_{0.33}Nb_{0.67-x}FeₓO_{3-δ} and BaMg_{0.33}Nb_{0.67-x}FeₓO_{3-δ}.

21. The catalyst of claim 19 wherein the Fe content is varied from x=0 to x=0.33.

22. The catalyst of claim 19 wherein said Mg and said Fe are incorporated on said Nb site resulting in oxide ion vacancy creation.

23. The catalyst of claim 19 wherein said barium sites act as adsorption sites for methane while adjacent lattice oxygen remove two hydrogen atoms as water.

24. The catalyst of claim 19 wherein said barium niobate-based cubic perovskite structure has the chemical formula of BaCa_{0.33}Nb_{0.67-x}MₓO_{3-δ} and BaMg_{0.33}Nb_{0.67-x}MₓO_{3-δ} where M is one or more of Fe, Co, Ni, Y, Yb, or Pr and the M content is varied from x=0 to x=0.33.

25. A catalytic composition for oxidizing methane comprising: a barium niobate-based perovskite structure where, Mg and Ca has been used to dope the niobium sites along with Fe.

26. The catalyst of claim 25 wherein said barium niobate-based cubic perovskite structure has the chemical formula of BaCa_{0.33}Nb_{0.67-x}FeₓO_{3-δ} and BaMg_{0.33}Nb_{0.67-x}FeₓO_{3-δ}.

27. The catalyst of claim 25 wherein the Fe content is varied from x=0 to x=0.33.

28. The claim of catalyst 25 wherein the Mg and Ca content is varied from 0.0 to 0.40

29. The catalyst of claim 25 wherein said Ca and said Fe are incorporated on said Nb site resulting in oxide ion vacancy creation.

30. The catalyst of claim 25 wherein said barium sites act as adsorption sites for methane while adjacent lattice oxygen remove two hydrogen atoms as water.

31. A catalyst comprising: a barium niobate-based perovskite structure where, one or both of Mg and Ca has been used to dope the niobium sites along with one or more of Fe, Ni, Co, Y, Yb, W, Ta, and Pr.

32. The catalyst of claim 31 wherein said barium niobate-based perovskite structure has the chemical formula of BaCa_{0.33}Nb_{0.67-x-y}M1ₓM2_{y}O_{3-δ} and BaMg_{0.33}Nb_{0.67-x-y}M1ₓM2_{y}O_{3-δ}

33. The catalyst of claim 31 wherein the M1 and M2 are chosen from Fe, Ni, Co, Y, Yb, W, Ta, and Pr and their content is varied from x=0 to x=0.50 and y=0 to y=0.50.

34. The catalyst of claim 31 wherein said Mg and said Fe are incorporated on said Nb site resulting in oxide ion vacancy creation.

35. The catalyst of claim 31 wherein lattice oxygen sites act as adsorption sites for hydrogen abstraction from methane to create CH3 groups.

36. The catalyst of claim 31 wherein surface oxygen sites act as adsorption sites for hydrogen abstraction from methane to create CH3 groups.
